(19) United States
(12) Patent Application Publication
(10) Pub. No.: US 2007/0184723 A1
(43) Pub. Date: Aug. 9, 2007

(54) Modular storage system, components therefor, storage method & kit

(76) Inventor: Benjamin Murphy, Rancho Santa Margarita, CA (US)

Correspondence Address: CONNORS ASSOCIATES, 1600 DOVE ST, SUITE 220, NEWPORT BEACH, CA, 92660, US

(21) Appl. No.: 10/591,219

(22) PCT Filed: Mar. 2, 2005
(86) PCT No.: PCT/US05/06648

§ 371 Date: Aug. 31, 2006

Related U.S. Application Data
(60) Provisional application No. 60/550,252, filed on Mar. 3, 2004.

(51) Int. Cl. H01R 24/00

(52) U.S. Cl. 439/676

(57) ABSTRACT

A modular storage system includes one version using clip members to attach vertical panels to a free standing support structure and another version uses a horizontal cleat or mounting members fastened to a vertical wall to support vertical panels to support vertical panels. The panels may be detachably mounted.

### INCORPORATION BY REFERENCE

The inventor incorporates herein by reference any and all U.S. patents, U.S. patent applications, and other documents cited or referred to in this application.

### DEFINITIONS

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

The word “rhomboidal” shall mean shaped somewhat like a rhombus or rhomboid.

### BACKGROUND OF INVENTION

In many situations merchandise or other items displayed or stored in a modular storage system that upon assembly creates parallel rows of horizontal shelving commonly found in retail stores and other venues. Typical modular storage systems are sold by Kitchen Craft, Streater, California Cabinets, and Darling Fixtures. Such a system may be a wall unit with horizontal shelving only on one side so that an opposed side may be pushed against a wall. Or the system may be a row unit with horizontal shelving projecting from both sides so that a number of the row units are spaced apart next to each other to create parallel rows of shelving. Both units are commonly referred to as a “gondola.” The base of a conventional gondola is a standard length, typically either 3 or 4 feet, and a standard width typically either 18 or 22 inches.

The horizontal shelves are supported by brackets detachably connected to vertical uprights. In many cases these vertical uprights are attached to a generally horizontal base that rests on the floor of, for example, a retail store. In many instances this base has to be leveled with shims pushed into place between the bottom of the base and a non-level floor. Peg-boards are in some instances connected between the vertical uprights to provide point of sale sites and rigidity to the gondola. There are holes in the peg-boards positioned on a grid with a hole measured at its center every inch and the holes aligned in both vertical and horizontal directions. Attachments for displaying merchandise or other items are inserted into these holes to connect them to the peg-boards. These attachments may be easily detached and repositioned as desired.

The vertical uprights are commonly elongated hollow metal structures with a rectangular cross-section and have along an outer face a series of indexing sites positioned in a row in an equally spaced apart sequence at a standard spacing of 1 inch on centers. Typically these indexing sites are openings in the face of the vertical upright into which fit snugly hook-shaped connectors extending from a rear edge of a bracket for a shelf. When the hook-shaped connectors are inserted into the sites, the bracket extends outward generally at a right angle to the face of the vertical upright. A pair of horizontally aligned brackets connected to adjacent vertical uprights support a shelf. In addition to the brackets and shelves, other components of the system may be used such as, for example, baskets, peg-board attachments, hangers, etc. The vertical uprights have a standard height of about 78 to about 86 inches.

It would be highly desirable from a sales perspective to create cabinets that would be compatible with the modular systems currently in use. Such cabinets could be used to display merchandise in a more appealing manner and create an image of higher quality merchandise that commands a higher price. A problem in making cabinets is “racking.” A conventional cabinet has a top panel, a bottom panel, a pair of side panels having their respective top and bottom edges fastened to the top and bottom panels, and a fifth component such a back panel or diagonal back brace. The fifth element prevents racking. Such a fifth anti-racking element is, however, incompatible with the modular storage systems commonly in use in retail stores. Currently, a cabinet is custom made and then attached to a conventional gondola.

### SUMMARY OF INVENTION

This invention has one or more features as discussed subsequently herein. After reading the following section entitled “DETAILED DESCRIPTION OF SOME EMBODIMENTS OF THIS INVENTION,” one will understand how the features of this invention provide its benefits. These benefits include, but are not limited to: (a) providing cabinets that are modular and compatible with modular storage systems commonly in use in retail stores or other venues, (b) cabinets or shelving that is a non-standard length to enable more efficient use of the storage space available, (c) components that are easy to manufacture and are compatible with modular storage systems commonly in use in retail stores or other venues, (d) panels detachably connected to gondola wall and row units that facilitate constructing a cabinet without the need for a fifth anti-racking element, (e) shelf clip members that are of identical shape and that may be conveniently used at different locations on a panel by simply inverting, (f) a rail member that may be detachably connected between conventional vertical uprights to support a vertically oriented panel, (g) a panel clip member for detachably connecting a panel to wall and row units, and (h) other components compatible with the modular storage systems commonly in use in retail stores or other venues, and (h) providing a modular storage system adapted to be mounted to a vertical wall.

There are two versions of the modular storage system of this invention. One version uses clip members to mount side panels vertically to a support structure, typically free standing. The other version is adapted to mount the panels to a vertical wall. Without limiting the scope of this invention as expressed by the claims both versions are discussed briefly below in this “SUMMARY OF INVENTION.”

### Version 1

Version 1 includes one or more, but not necessarily all, of the following features.

First, in one embodiment a modular storage system is provided where at least some of its components are connected directly or indirectly along vertical and horizontal directions to a support structure. In this embodiment, at least one pair of panels may be spaced apart and connected to the support structure by a plurality of panel clip members, which may be detachably connected. The panel clip members may include one segment connected to the support structure and another segment connected to a panel. The panel clip members orient the panel to which they are connected substantially vertically. The panel extends outward from the support structure at substantially a right angle.

Second, some panel clip members may be interactive with only one side of a panel to which they are connected; some panel clip members may be interactive with both sides of a panel to which they are to be connected. There may be a right hand side panel, a left hand side panel, and a center side panel. In such an embodiment, a pair of right hand panel clip members are connected to the right hand side panel, pair of left hand panel clip members connected to the left hand side panel, and pair of center panel clip members connected to the center panel. The panels may interact with different types of clip members as may be suitable under the individual circumstances.

Third, at least one substantially horizontally oriented member may extend between the panels, for example, a shelf, which may be adjustable or fixed. This horizontally oriented member may have opposed ends with one opposed end connected to one panel by a first pair of spaced apart shelf clip members and the other opposed end connected to the other panel by a second pair of spaced apart shelf clip members. In one embodiment, each shelf clip member is detachable and comprises first and second finger elements intersecting to form a substantially right angle with respect to each other. The first finger element is above the second finger element and detachably connected to one panel and the second finger element is detachably connected to one opposed end of the shelf member. A third finger element extends outward at the intersection of the first and second finger elements to form an angle greater than 90° and less than 180° with respect to one of the first and second finger elements. The third finger is detachably connected to the one panel.

Forth, in one embodiment one panel forms one side of the modular storage system and includes a substantially planar section having opposed sides and opposed lateral edges. Only one of the opposed sides has a pair of spaced apart longitudinally extending slots therein with a series of openings nearby each slot in a row extending substantially longitudinally. Each row is substantially parallel to its nearby slot. One of the opposed lateral edges has therein a substantially longitudinally extending slot into which extends a portion of at least one of the panel clip members. For example, in one embodiment, there is pair of longitudinal grooves in the vertical panel at an angle with respect to a side of the panel that is greater than about 5° and less than about 90°, with each groove in the pair pointing away from each other. In another embodiment, more than two panels may be used in the modular storage system, for example, a third panel may be positioned between the pair of panels. This third panel may include a substantially planar section having opposed sides, both of said opposed sides having a pair of spaced apart longitudinally extending slots therein with a series of openings nearby each slot in a row extending substantially longitudinally, each said row being substantially parallel to its nearby slot. The horizontally oriented member may have a cavity on an underside thereof nearby an edge thereof that receives a portion of one shelf clip member upon connection therewith.

Fifth, spaced apart rail members may be used. The rail members may each be mounted on a substantially vertically oriented support structure in a substantially horizontal orientation. The panels may be connected to the rail members. The rail members may each comprises an elongated body member having opposed ends, each opposed end including a connector element interacting with a vertical upright to detachably connect the rail member to the vertical upright. The connector element may comprise a pair of prong elements spaced apart a predetermined distance greater than the length of one indexing site of a series of equally spaced apart indexing sites along the vertical upright. This enables the prong elements to be detachably connected to a pair of the sites separated by at least one indexing site. The prong elements may be substantially at a right angle with respect to the body member of the vertical upright.

Sixth, the modular storage system may include at least one pair of substantially identical shelf brackets. Both brackets of the pair may be detachably connected to a common rail member to position substantially horizontal a shelf member attached thereto. Each shelf bracket may comprise a pair of planar elements spaced apart a distance substantially equal to the thickness of a shelf member to be attached thereto and the shelf member has an edge disposed between the planar elements. At least one shelf bracket may have a first segment adapted to be detachably connected one rail member and a second segment adapted to support a shelf member on a top portion thereof. At least one shelf bracket may have a first segment adapted to be detachably connected to one rail member and a second segment including an upper edge with at least one pair of spaced apart grooves therein that interact with a storage member of the modular storage system.

Seventh, one embodiment may include a shelf attachment device that interacts with a vertical upright including a series of indexing sites positioned in an equally spaced apart sequence. The shelf attachment device may comprise an elongated body with at least one segment detachably connected to at least one of the rail members and configured to orient the shelf attachment device substantially vertically. The elongated body may have an edge including a series indexing sites in a row, each site being in a predetermined position in an equally spaced apart sequence substantially identical to the position of the indexing sites along the vertical upright.

Eighth, one embodiment may include a shelf manager attachment that is detachably connected to a rail member. The shelf manager attachment may include at least one support member adapted to carry a shelf member thereon and allow the shelf member to be moved laterally.

Ninth, one embodiment may employ a gondola support having a base and a plurality of uprights in a row extending from the base at an angle of substantially 90°. The uprights may include a series of indexing sites positioned in an equally spaced apart sequence that are interactive with the rail members.

### Version 2

In Version 2 a modular storage system adapted to be mounted to a vertical wall is provided, and it does not use clip members like those used in Version 1. Version 2 includes one or more, but not necessarily all, of the following features.

One, a pair of horizontal mounting members may be fixedly attached to the vertical wall and spaced apart vertically a predetermined distance or the mounting members may be attached to a back panel and used with cleat members attached to the vertical wall. Each mounting member has a predetermined cross-sectional configuration, for example, rhomboidal having upper and lower horizontal edges forming acute angles with respect to the wall. The mounting members may be substantially in registration. The cross-sectional configurations of each mounting member may be substantially identical. The cleat members each may have a pair of opposed horizontal edges, with only an upper horizontal edge forming an acute angle with respect to the wall. The cleat members may be substantially in registration. The cross-sectional configurations of each cleat member may be substantially identical. The cleat members may be eliminated and only the mounting members used. The side panels are then mounted directly on the mounting members. In such a case, a back panel may or may not be used.

Two, at least one pair of side panels is employed. Each side panel has an inner edge with a pair of cut-a-way sections, one cut-a-way section having a configuration corresponding to the cross-sectional configuration of one of the mounting members and the other cut-a-way section having a configuration corresponding to the cross-sectional configuration of the other mounting member. The pair of cut-a-way sections are spaced apart a distance substantially equal to the distance between the mounting members and each individual cut-a-way section of the pair of cut-a-way sections is seated on one of the mounting members. The individual side panels are spaced apart along the pair of mounting members and are substantially vertically oriented and extend outward from the wall at substantially a right angle. At least one substantially horizontally oriented member may extend between the side panels. The side panels may be substantially in registration. The side panels may each be seated on a mounting member with the mounting member and cut-a-way section of each side panel fitting snugly together,

Three, a back panel may be employed having a pair of substantially horizontally oriented mounting members that are spaced apart vertically and fixedly attached to an exterior surface of the back panel. The mounting members each may have upper and lower substantially horizontal edges and a predetermined cross-sectional configuration. The lower edge of one of the mounting members engages the upper edge of one cleat member fixedly attached to the vertical wall and the lower edge of the other mounting member engages the upper edge of the other cleat member fixedly attached to the vertical wall. These lower edges each have an acute angle substantially equal to the acute angle of the cleat member upper edge being engaged.

Four, in an embodiment employing both mounting members and cleat members, the cleat members may each have a predetermined length that is less than the distance between the side panels. These cleat members are positioned relative to the back panel to provide a space between the wall and adjacent cleat members into which the edge of at least one side panel is received upon being seated on the mounting members which rest on the cleat members.

These features of Versions 1 and 2 of the modular storage system of this invention are not listed in any rank order nor is this list intended to be exhaustive. The modular storage system of this invention may also include, for example, a cabinet, a door, a doorframe for the door, a drawer, a drawer front, a face frame, molding, lighting, signage, a bin, a cubbyhole, or other furniture elements. This invention also includes a novel panel clip member, a shelf clip member, a rail member, panel, kit, and a method of storing items discussed subsequently in greater detail.

### DESCRIPTION OF DRAWING

Some embodiments of this invention, illustrating all its features, will now be discussed in detail. These embodiments depict the novel and non-obvious modular storage system, components therefor, kit, and method of this invention as shown in the accompanying drawing, which is for illustrative purposes only. This drawing includes the following figures (Figs.), with like numerals indicating like parts:

### Version 1

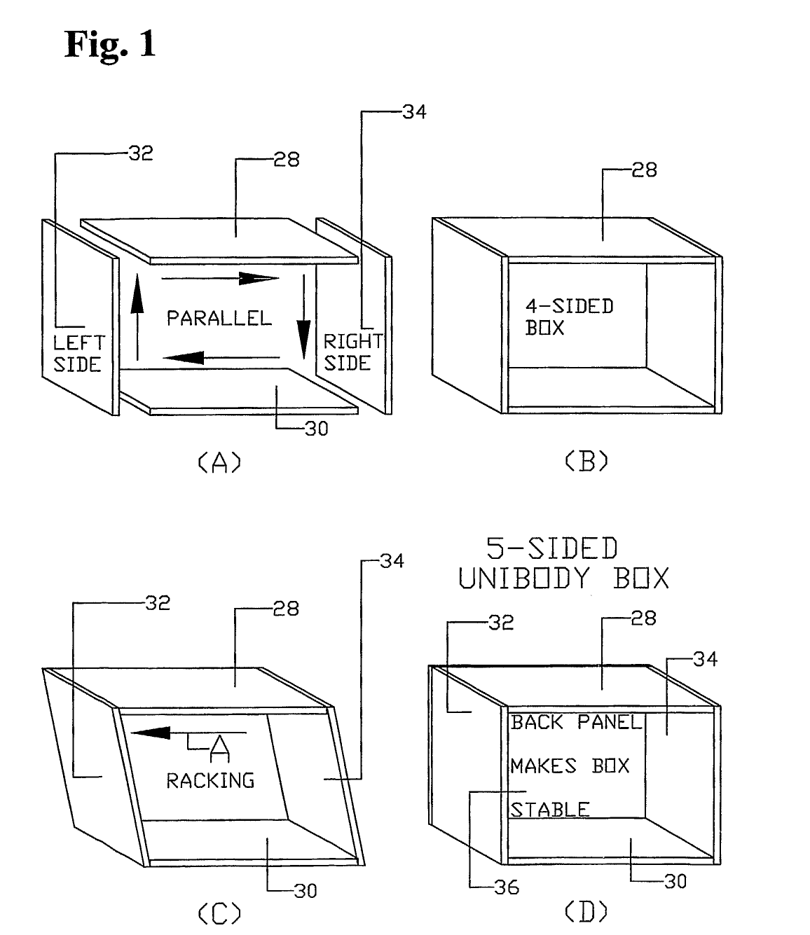

FIG. 1 is a schematic illustration of the racking problem experienced by conventional cabinets requiring a fifth element to prevent racking.

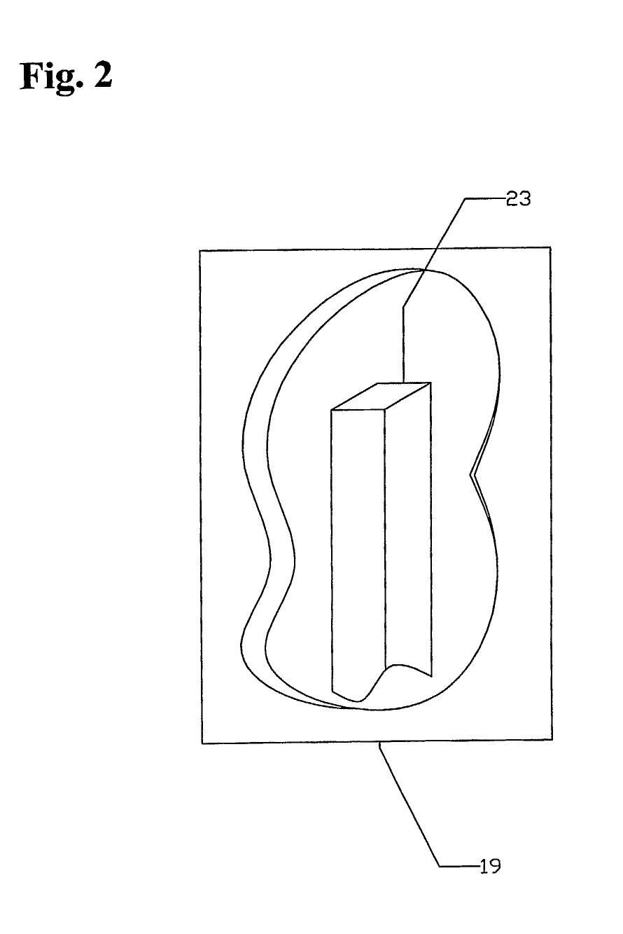

FIG. 2 illustrates a wall section with a cut-a-way portion exposing a stud.

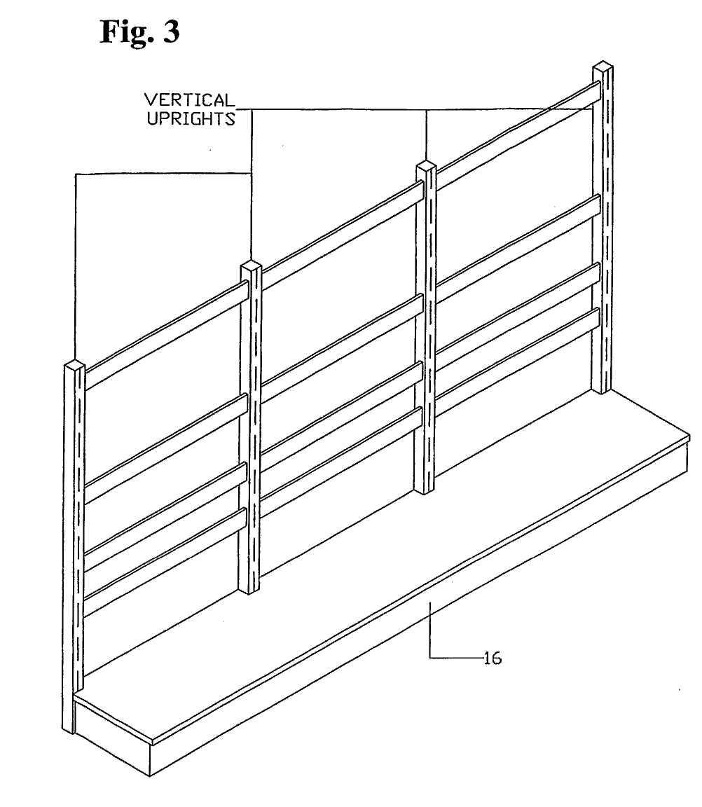

FIG. 3 is a wall unit used with the modular storage system of this invention.

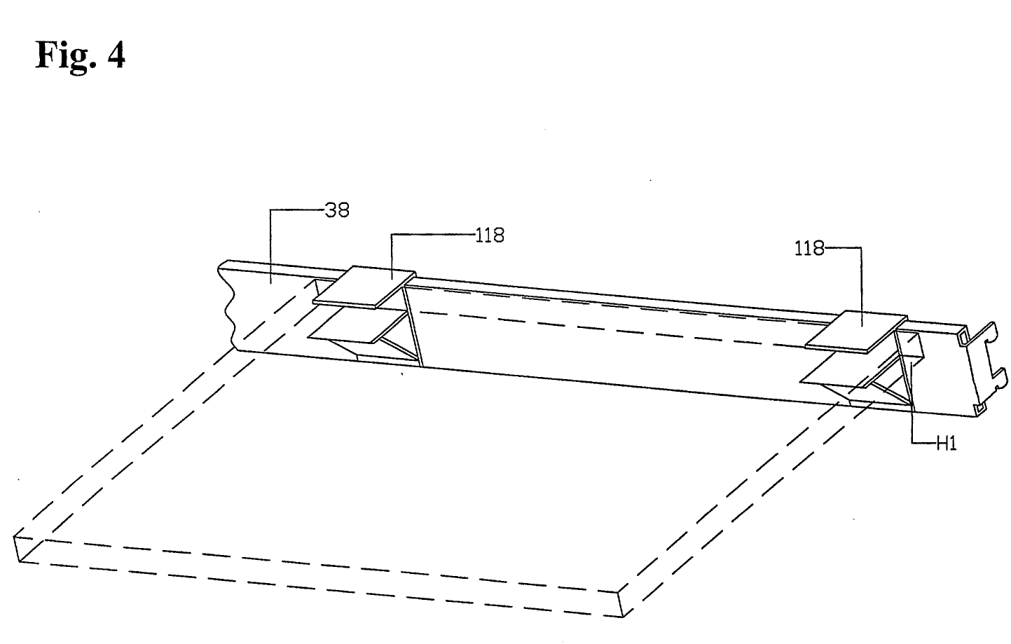

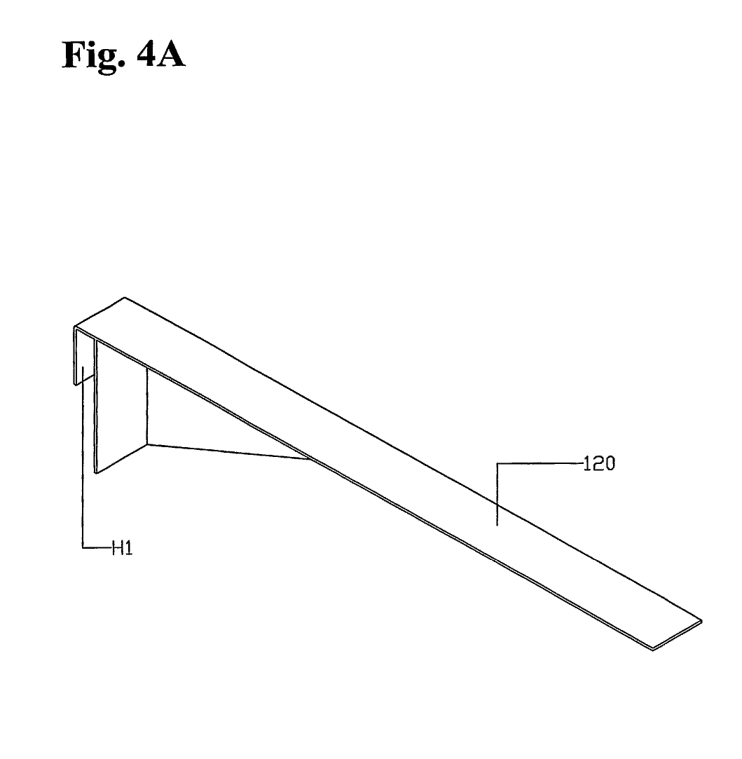

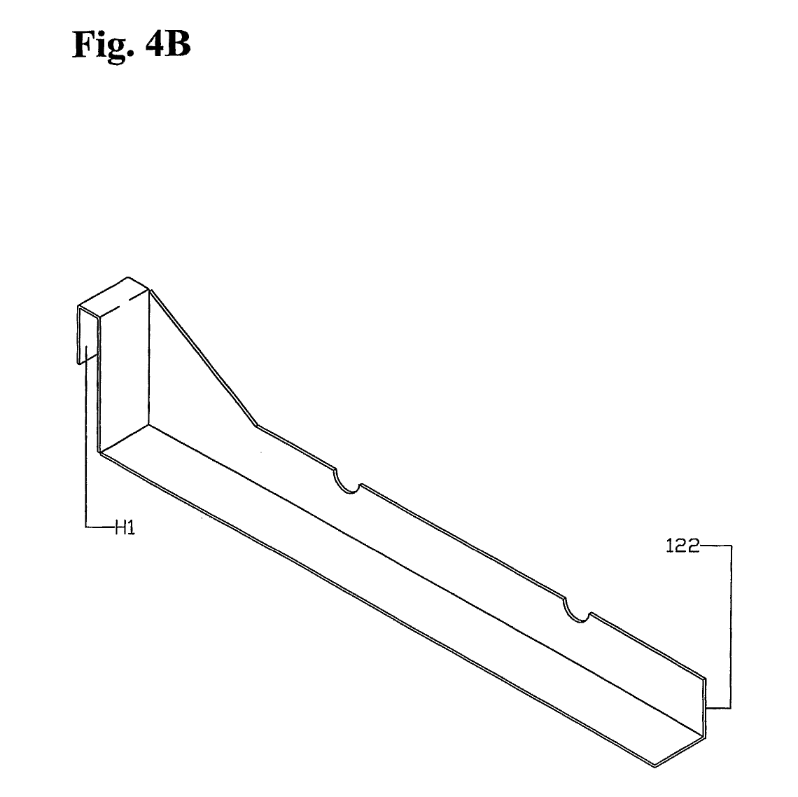

FIG. 4 is a perspective view of a pair of brackets detachably connected to a rail member of this invention holding a shelf shown in phantom lines.

FIG. 4A is a perspective view of a shelf bracket for supporting a shelf that may be connected to a rail member of this invention.

FIG. 4B is a perspective view of a basket bracket for supporting a basket that may be connected to a rail member of this invention.

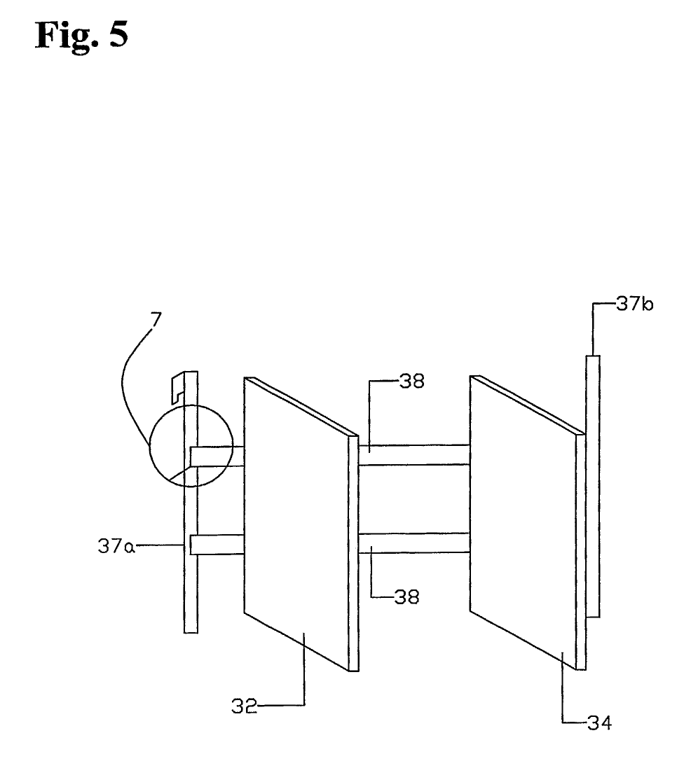

FIG. 5 is a partially assembled cabinet in the modular storage system of this invention showing the side panels connected to a rail member mounted between a pair of adjacent vertical uprights of the wall unit shown in FIG. 3.

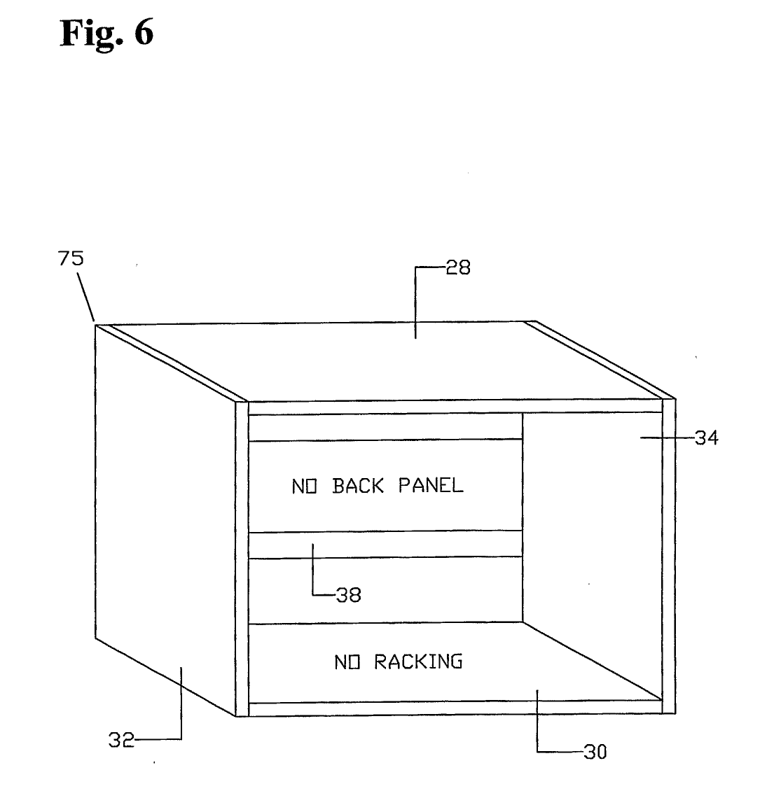

FIG. 6 depicts the top and bottom panels added to the partially assembled cabinet illustrated in FIG. 5.

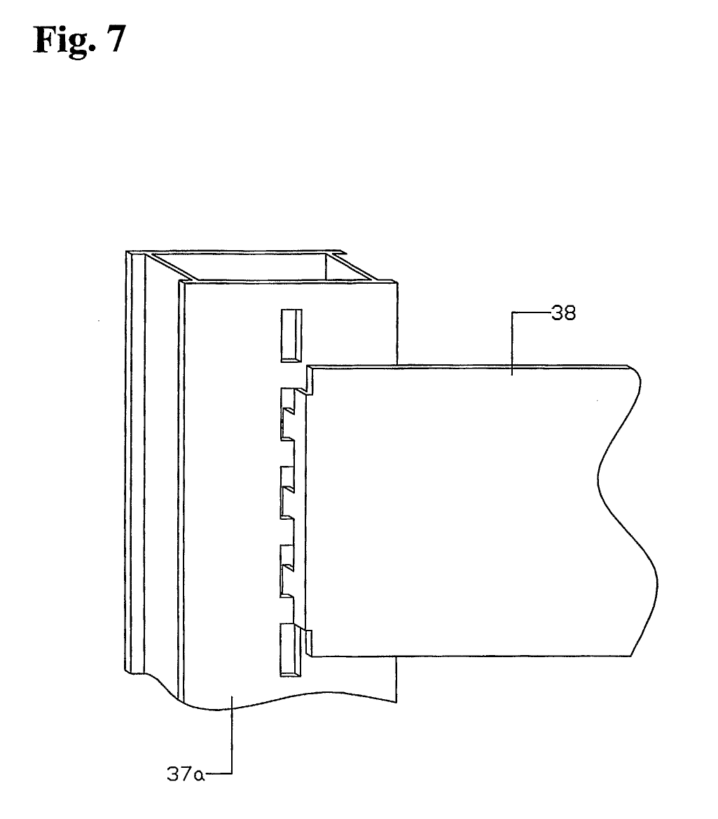

FIG. 7 is an enlarged, fragmentary perspective view taken along line 7 of FIG. 5.

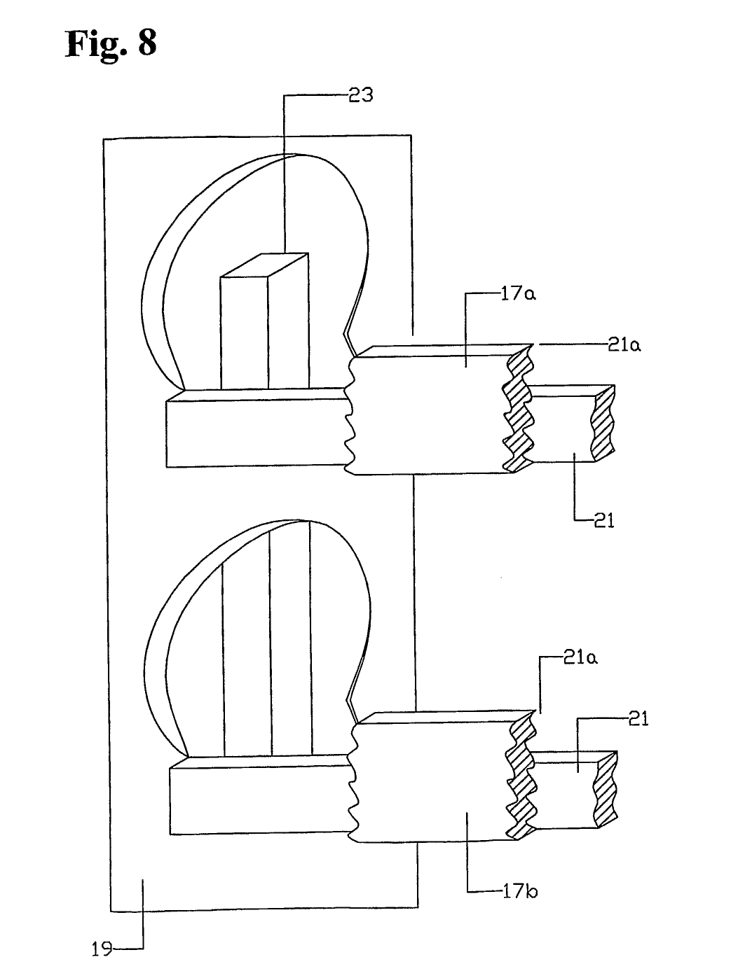

FIG. 8 is similar to FIG. 2 showing a horizontal support member fixedly attached between wall studs.

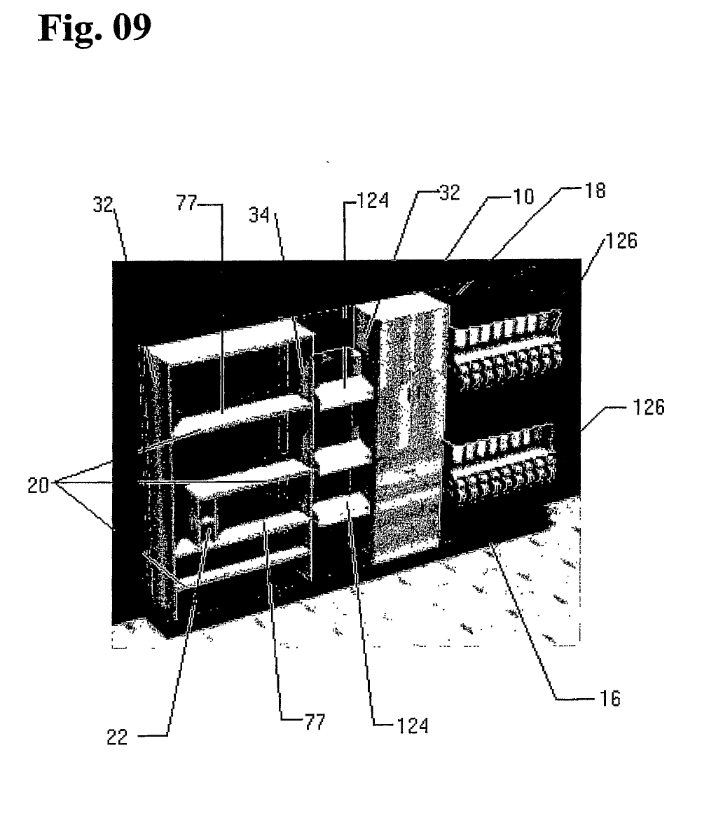

FIG. 9 is one embodiment of a completely assembled modular storage system of this invention.

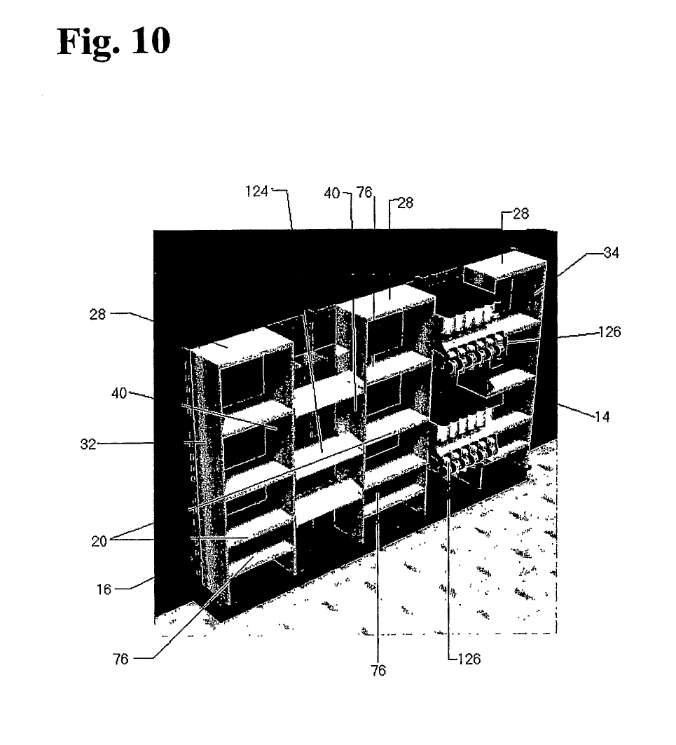

FIG. 10 is another embodiment of a completely assembled modular storage system of this invention.

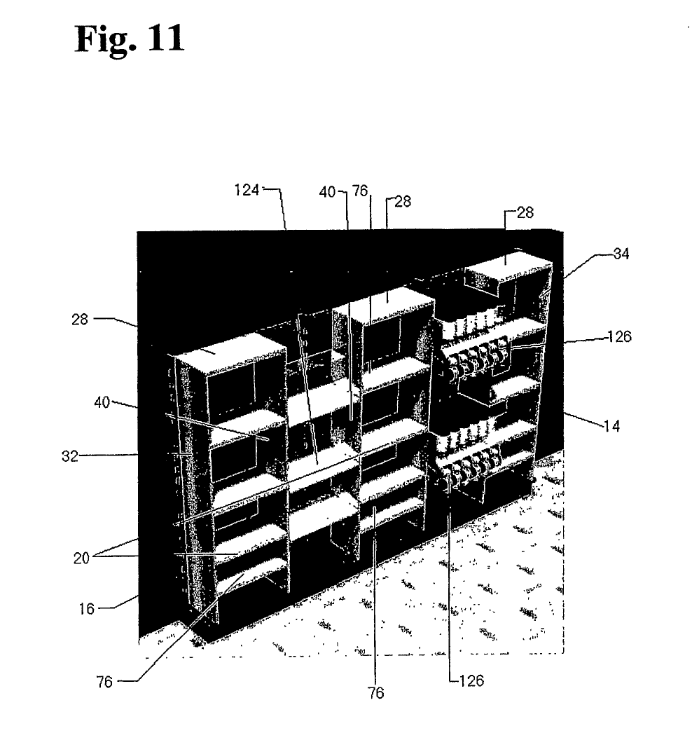

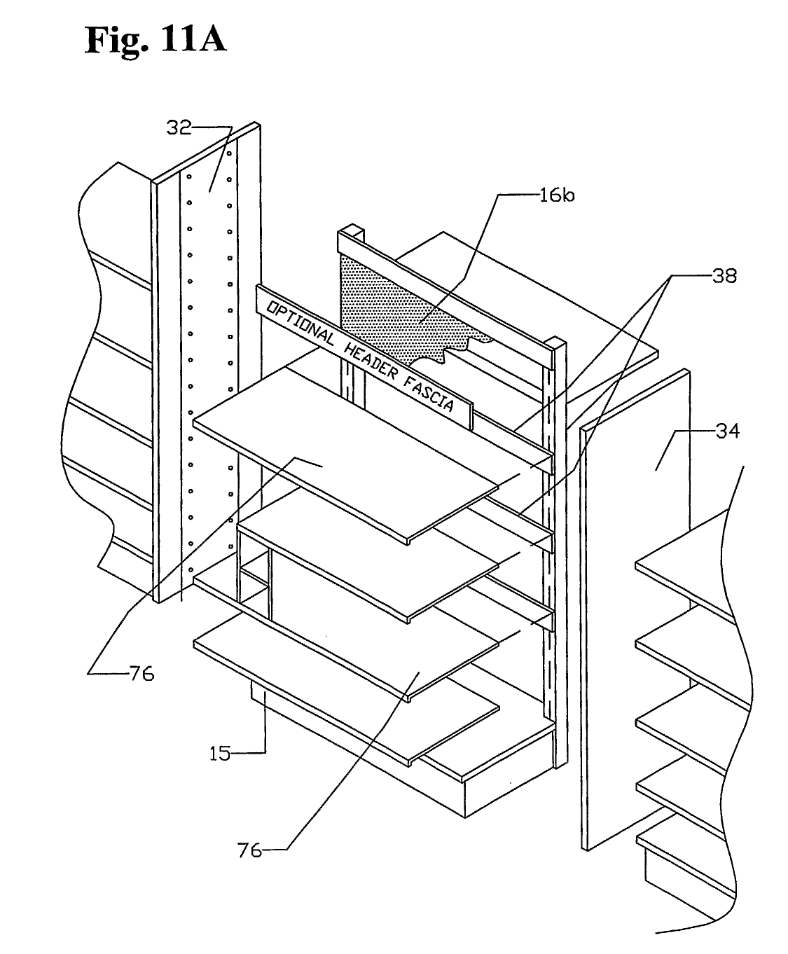

FIG. 11 is still another embodiment of a completely assembled modular storage system of this invention.

FIG. 11A is another embodiment of the modular storage system of this invention shown as disassembled.

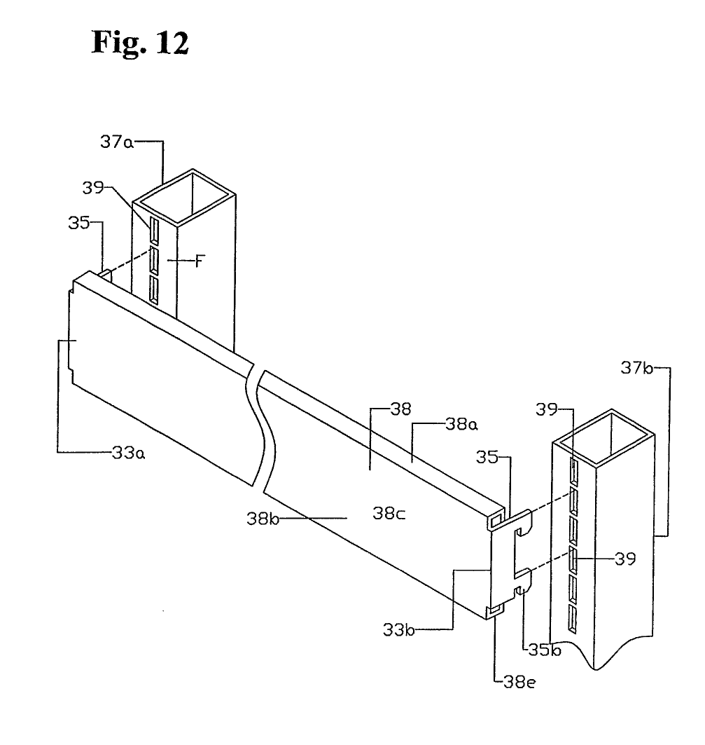

FIG. 12 is a perspective view showing a rail member of this invention being detachably connected to adjacent vertical uprights of a conventional gondola.

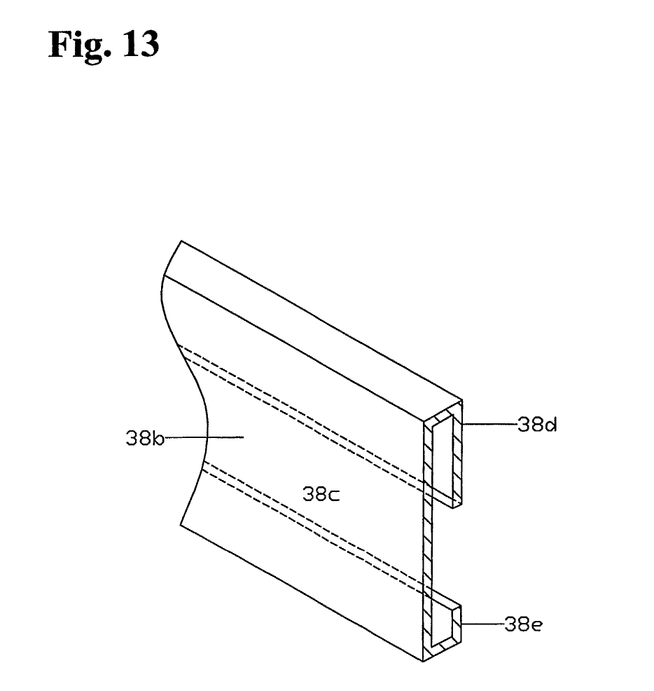

FIG. 13 is a cross-sectional view taken along line 13-13 of FIG. 12.

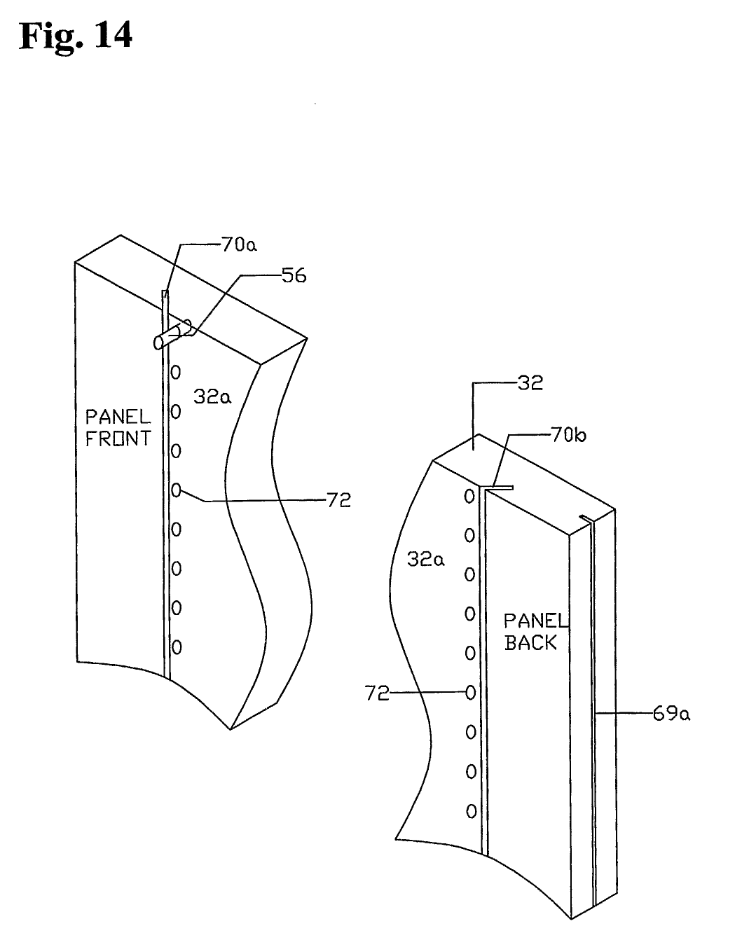

FIG. 14 is a perspective view, with sections broken away, of a left hand end panel of this invention.

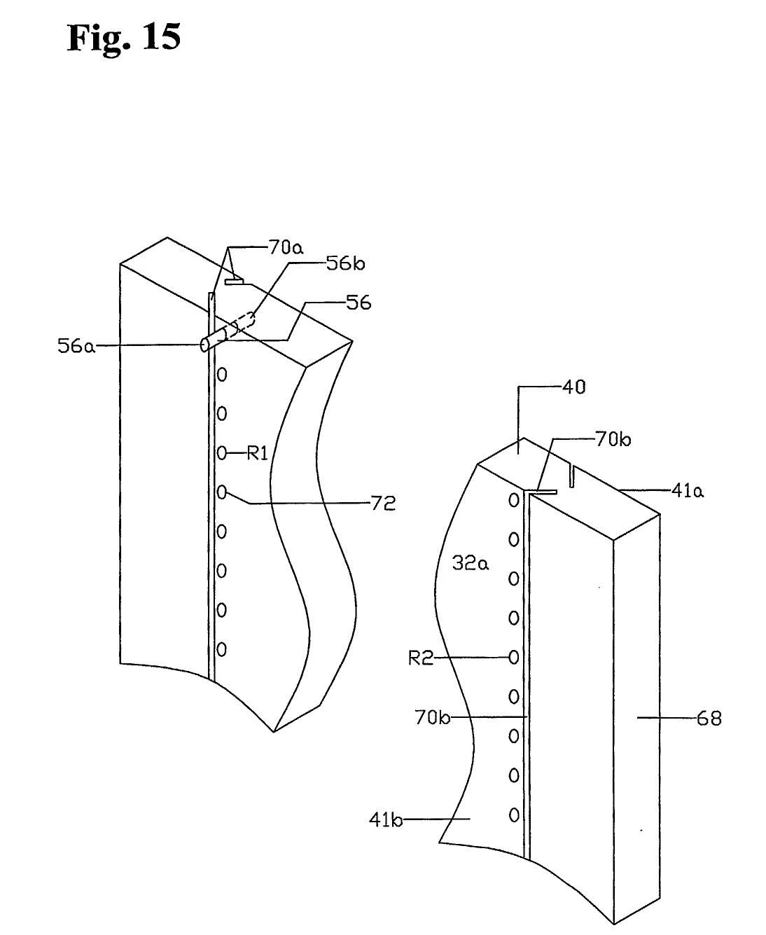

FIG. 15 is a perspective view, with sections broken away, of a divider panel of this invention.

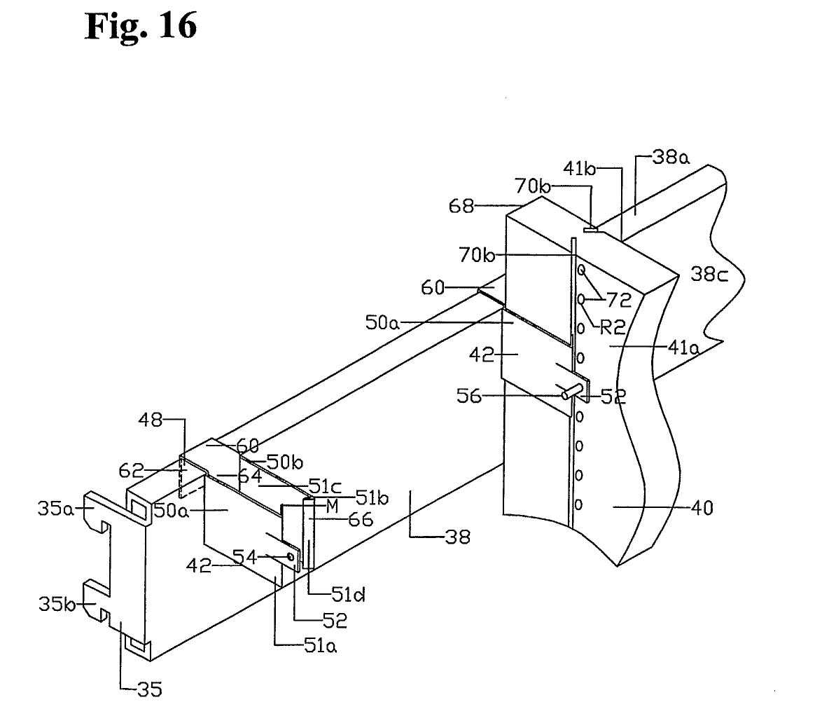

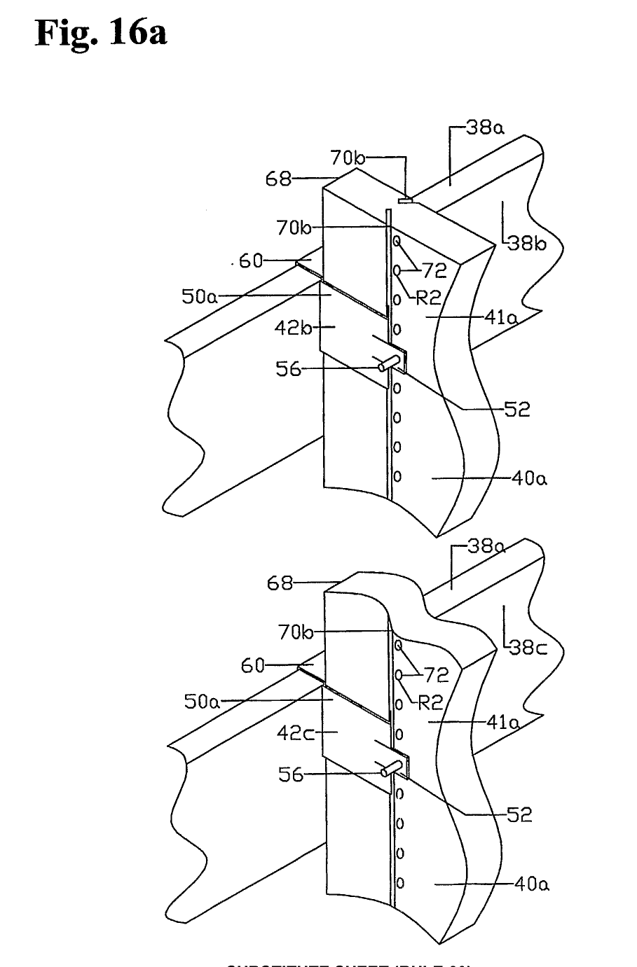

FIG. 16 is a perspective view, with sections broken away, of the divider panel shown in FIG. 16 being rigidly and detachably connected to the rail member shown in FIG. 12.

FIG. 16A is a perspective view, with sections broken away, of a long divider panel being rigidly and detachably connected by a pair of divider panel clips each clip connected to one of a pair of adjacent horizontal rail members.

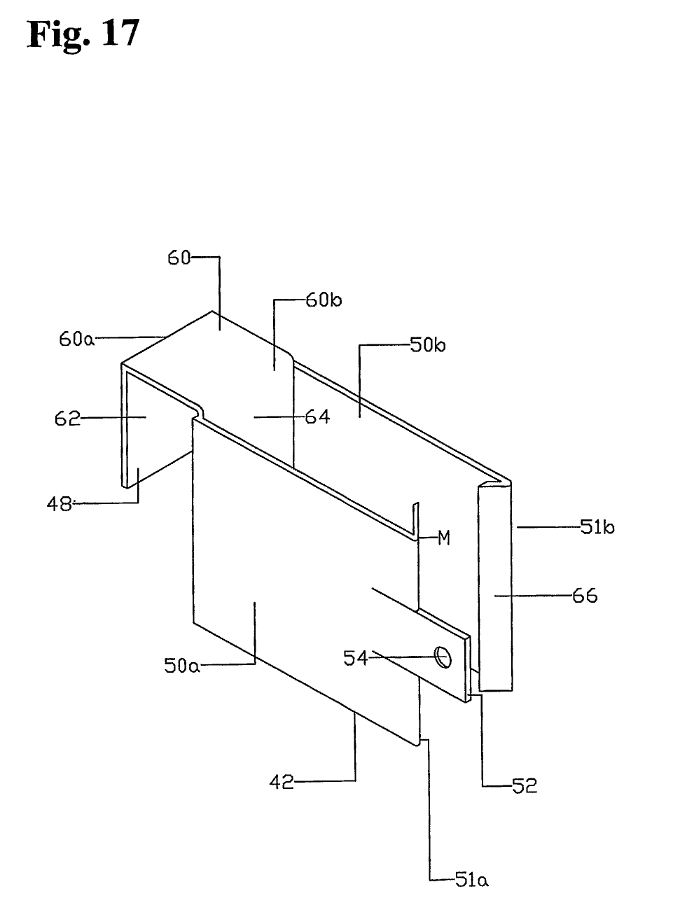

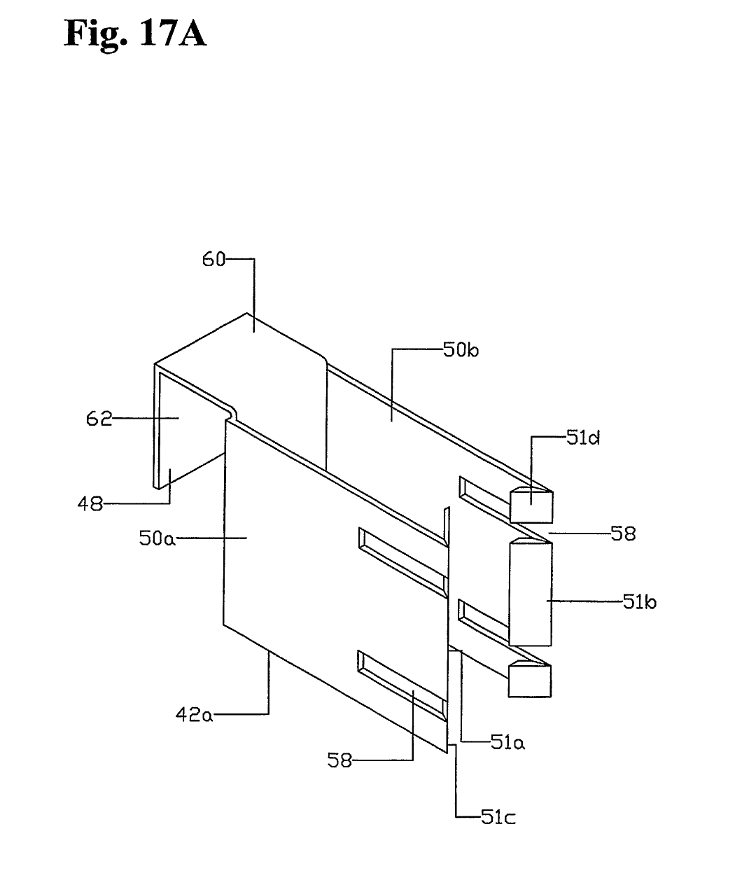

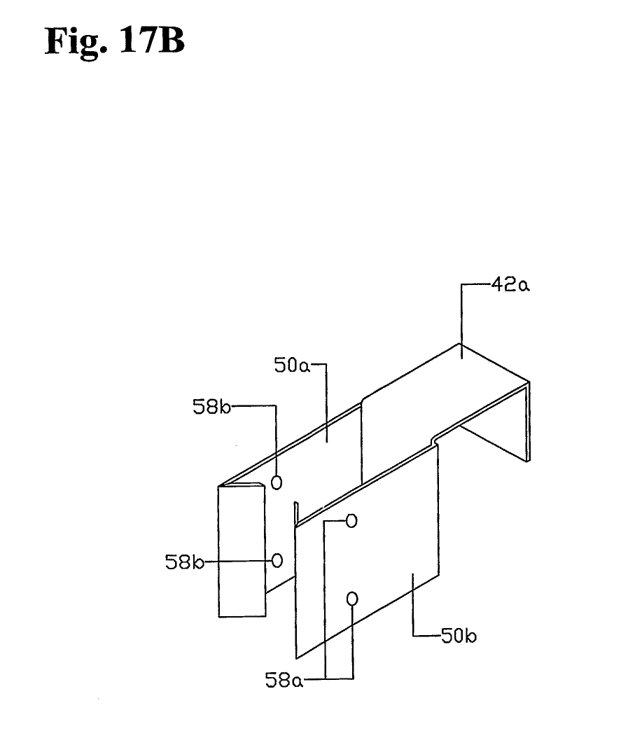

FIG. 17 is a perspective view of one embodiment of a divider panel clip of this invention.

FIG. 17A is a perspective view of another embodiment of a divider panel clip of this invention.

FIG. 17B is a perspective view of another embodiment of a divider panel clip of this invention.

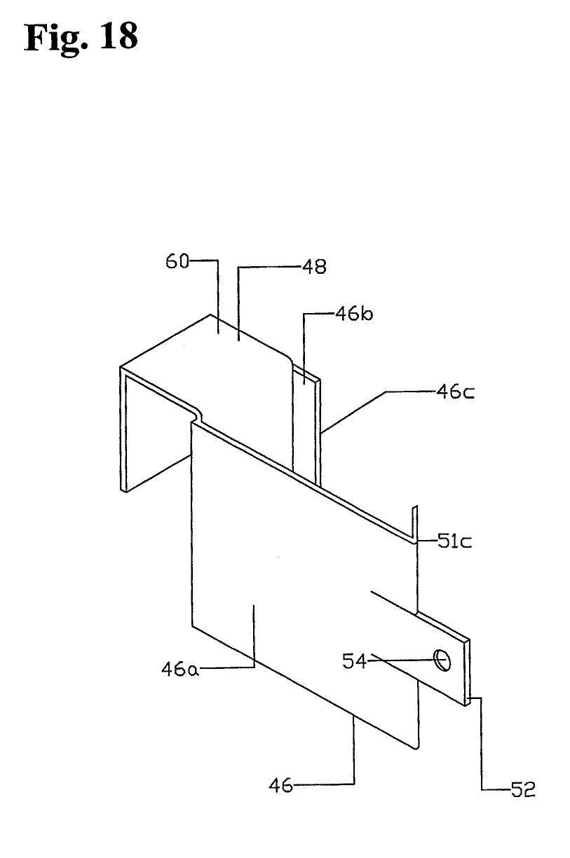

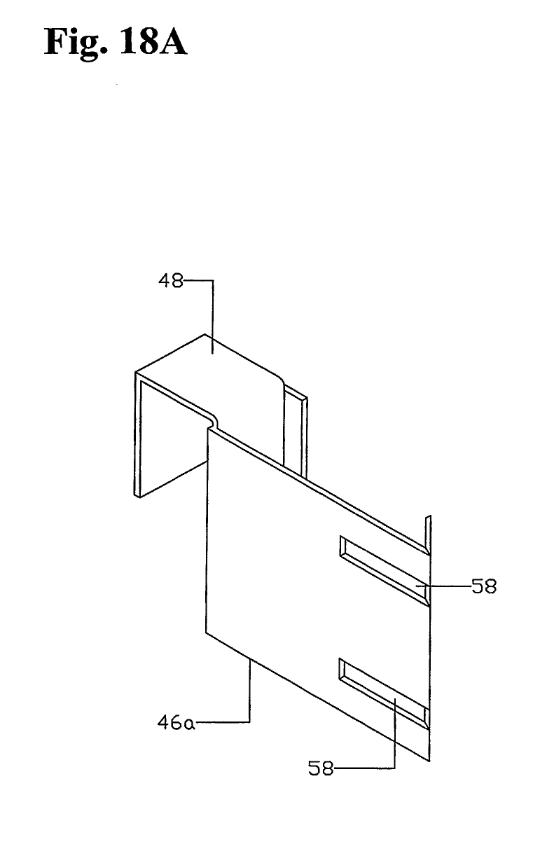

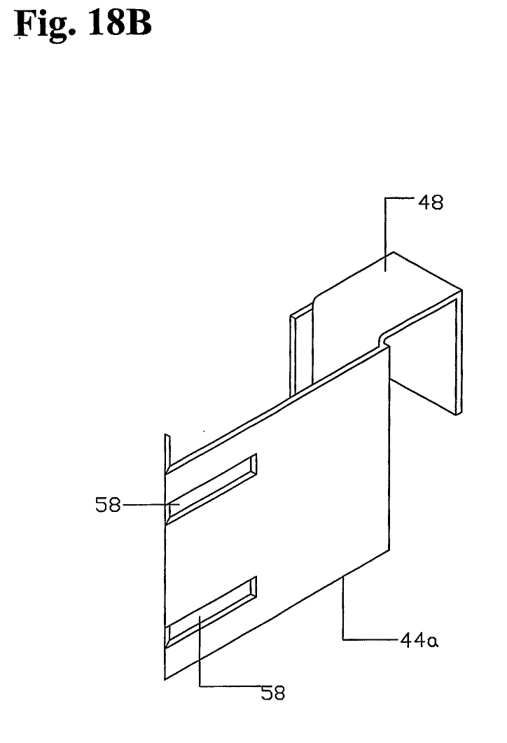

FIG. 18 is a perspective view of one embodiment of a right hand end panel clip of this invention.

FIG. 18A is a perspective view of another embodiment of a right hand end panel clip of this invention.

FIG. 18B is a perspective view of one embodiment of a left hand end panel clip of this invention.

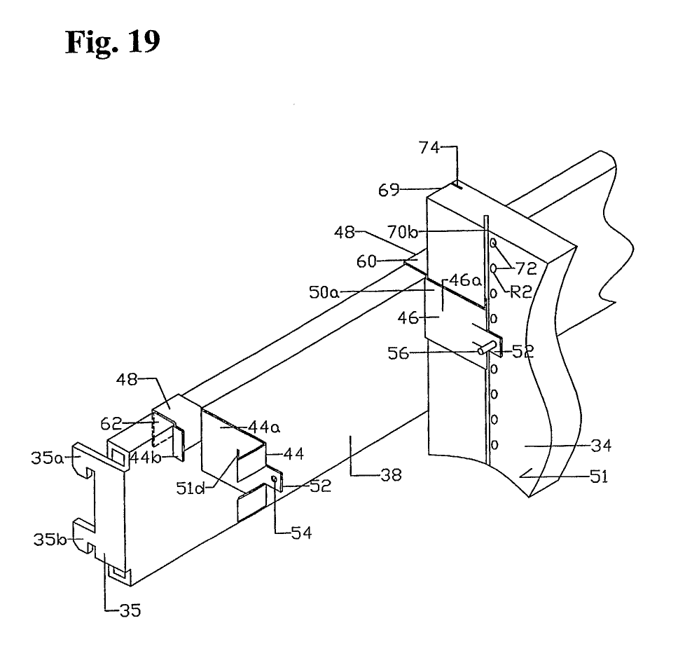

FIG. 19 is a perspective view, with sections broken away, of a right hand panel being attached by a right hand end panel clip to the rail member shown in FIG. 12.

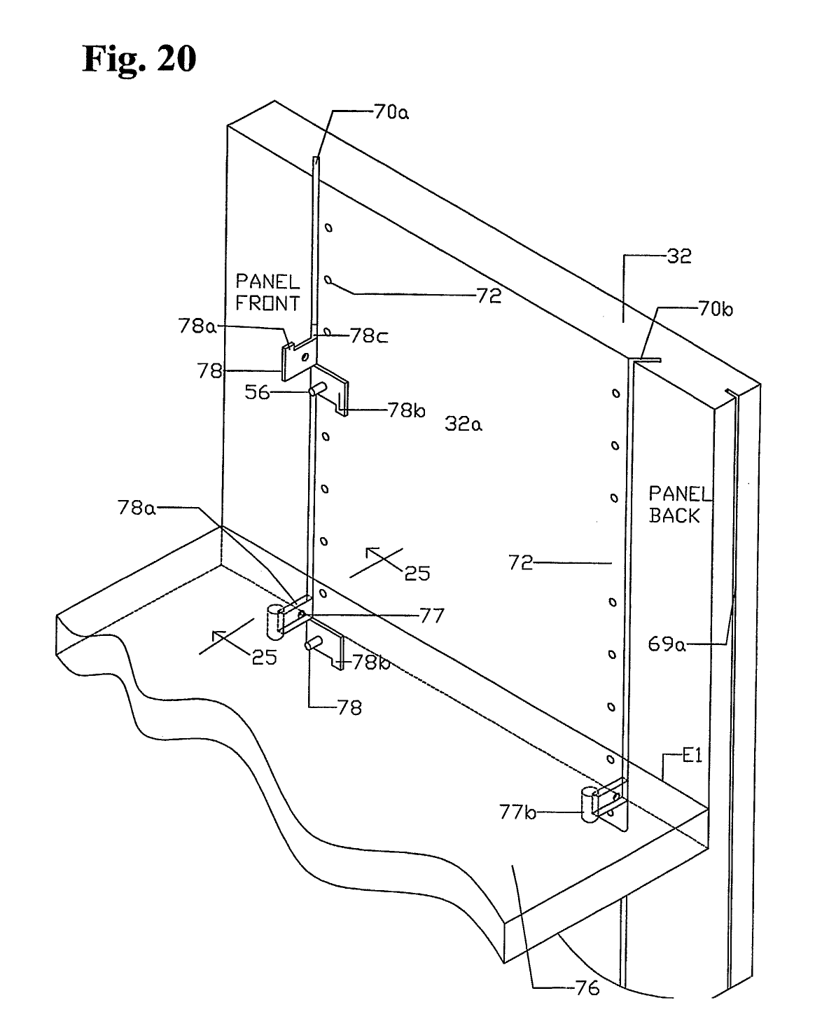

FIG. 20 is a perspective view, with sections broken away, of a shelf of this invention being detachably connected to the right hand panel shown in FIG. 19.

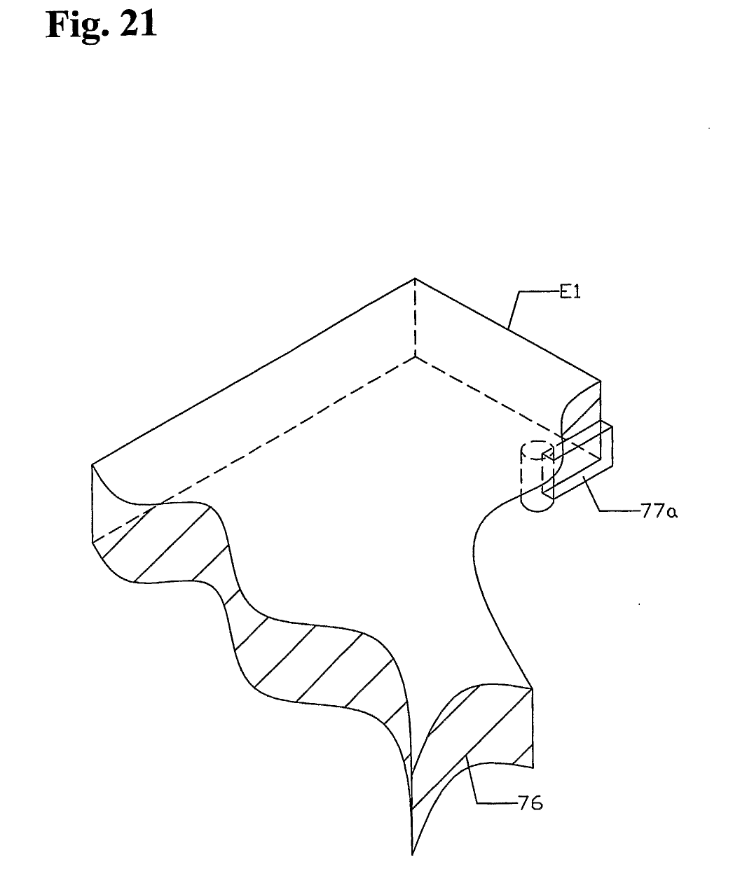

FIG. 21 is a fragmentary perspective view of a shelf of this invention.

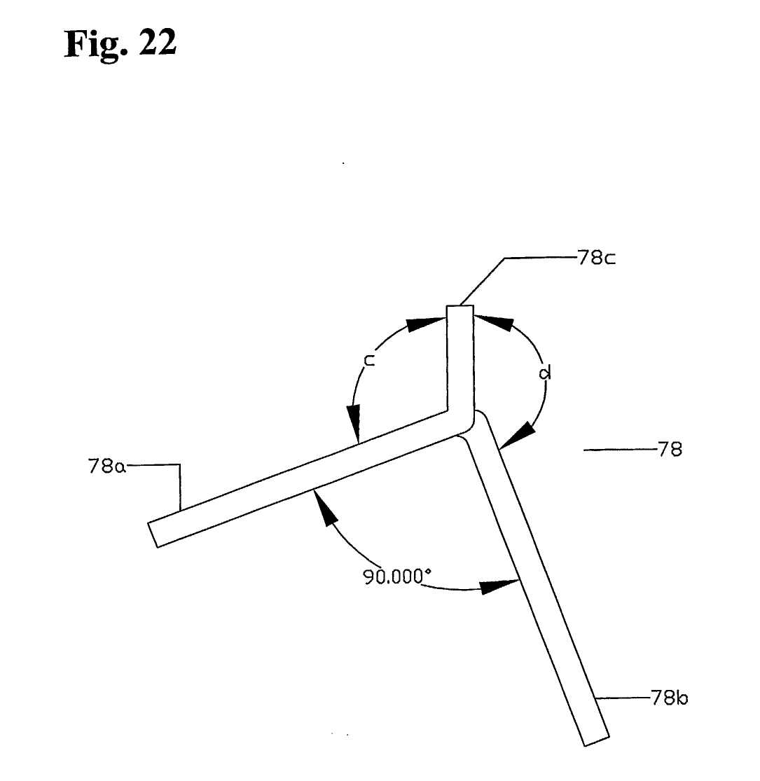

FIG. 22 is a top plan view of one embodiment of the shelf clip of this invention.

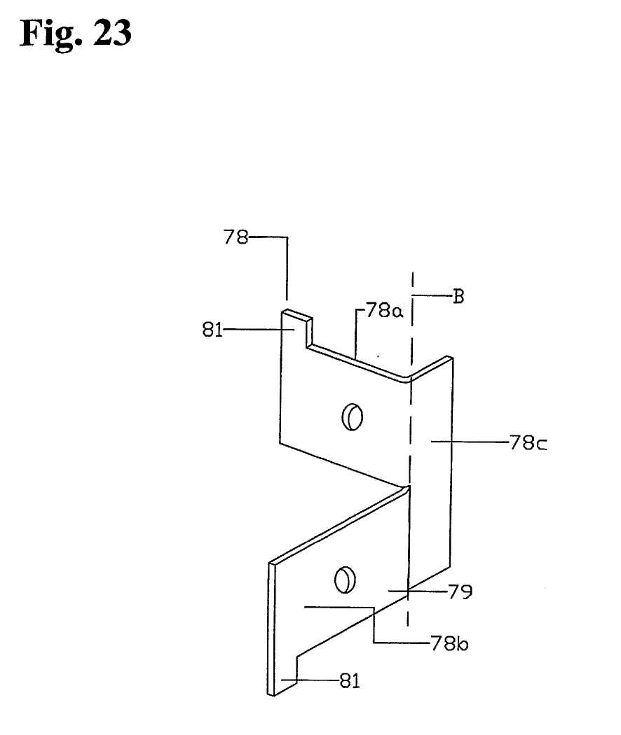

FIG. 23 is a rear perspective view of the shelf clip shown in FIG. 22.

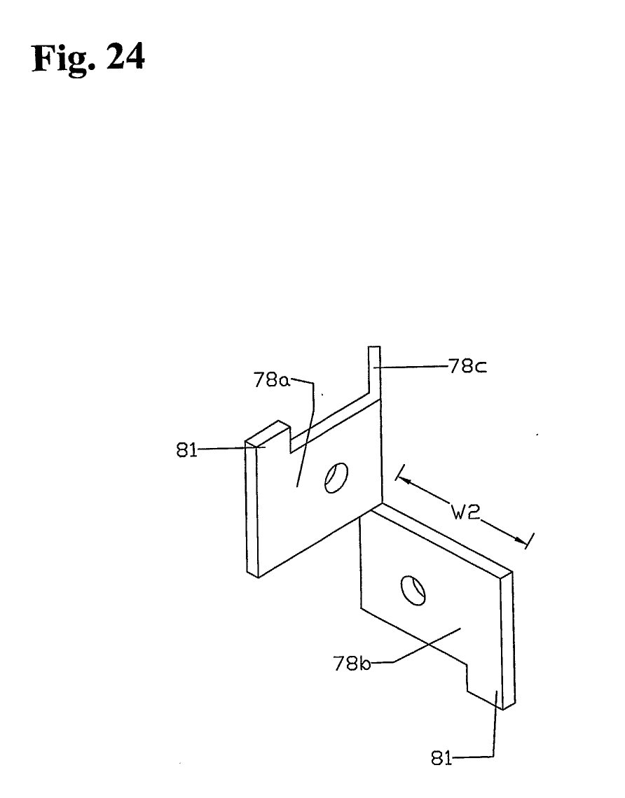

FIG. 24 is a front perspective view of the shelf clip shown in FIG. 22.

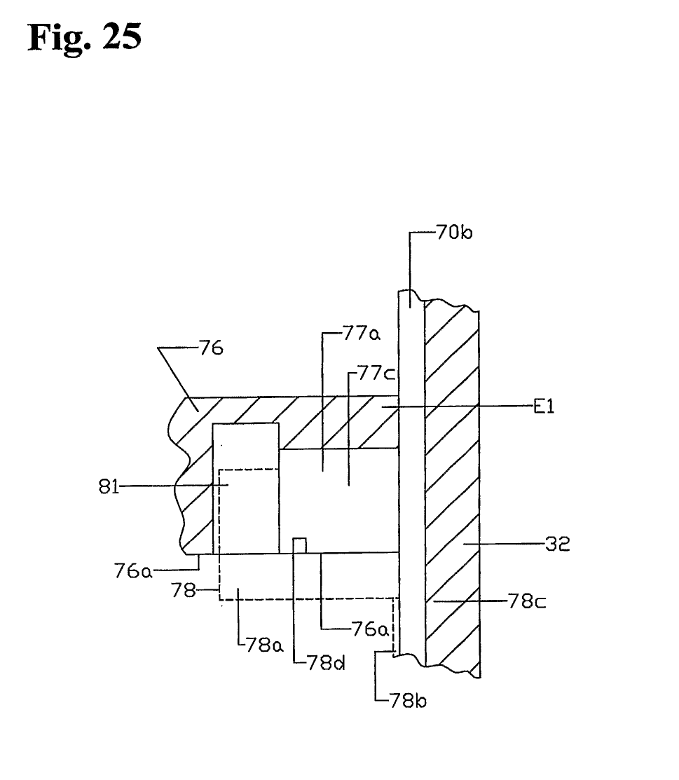

FIG. 25 is a cross-sectional view taken along line 25-25 of FIG. 20.

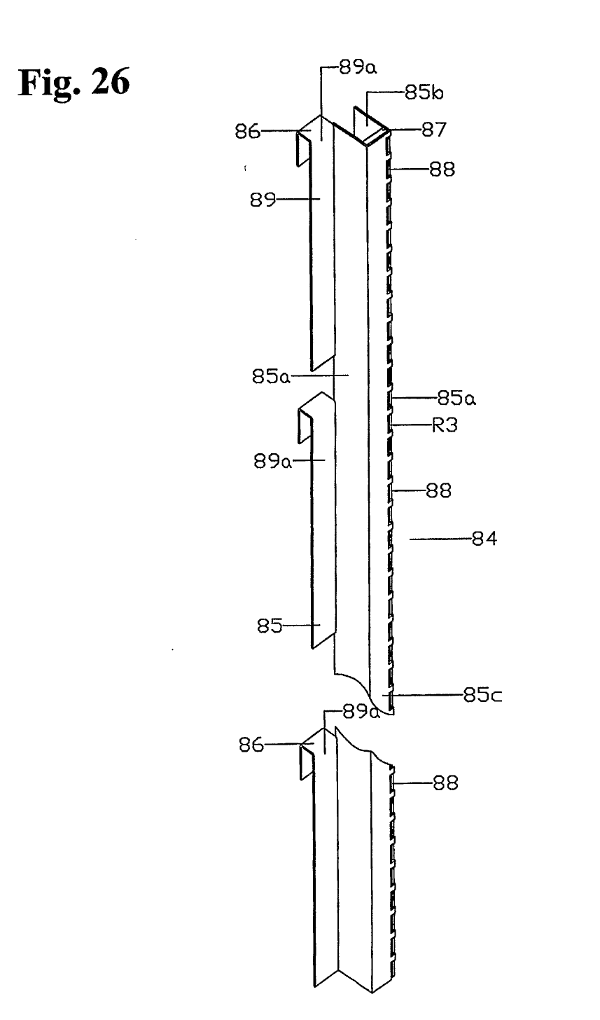

FIG. 26 is a perspective view, with sections broken away, of a shelf attachment device of this invention.

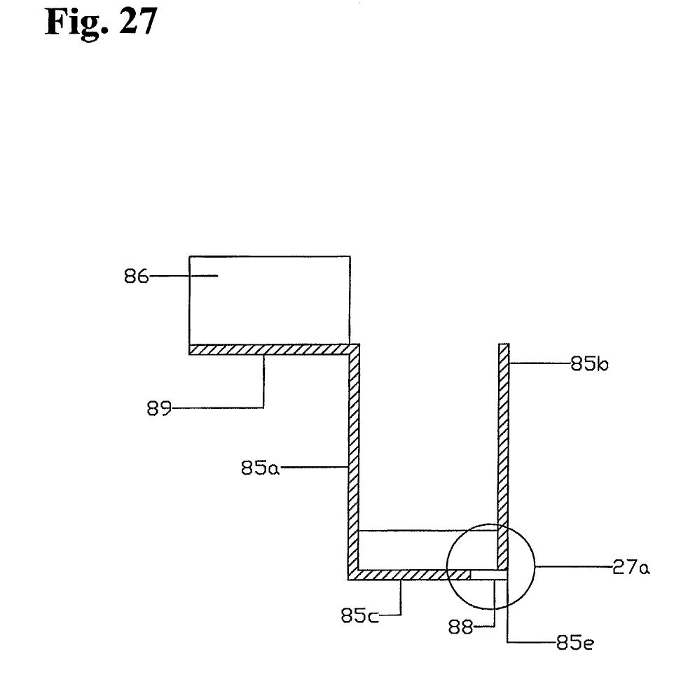

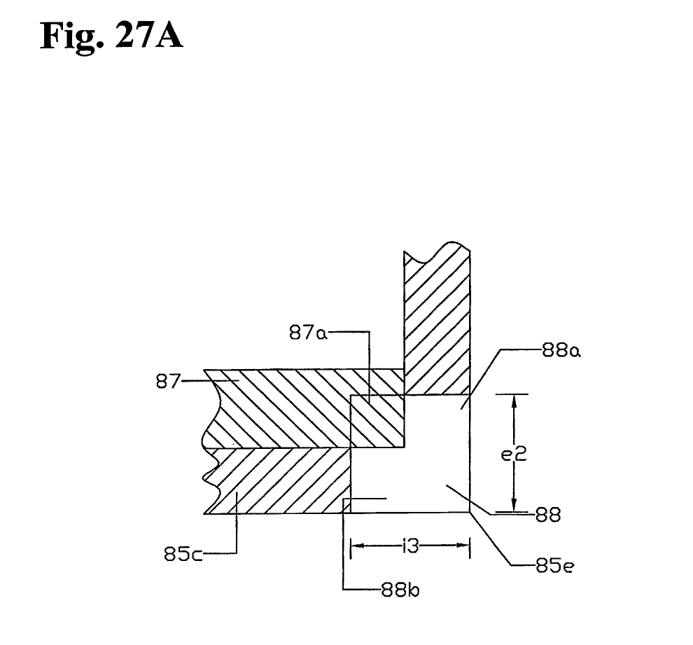

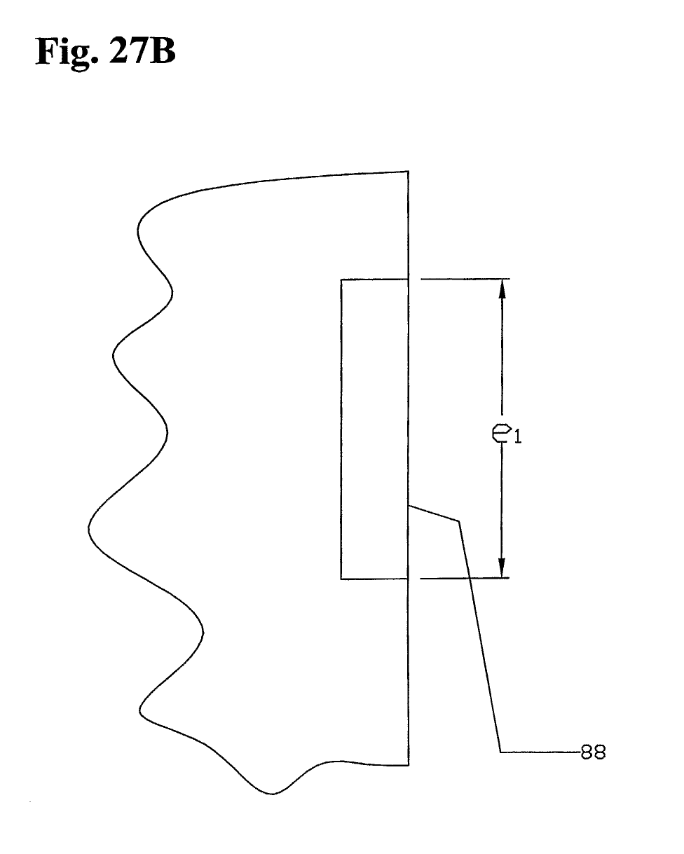

FIG. 27 is a cross-sectional view taken along line 27-27 of FIG. 26.

FIG. 27A is an enlarged, fragmentary cross-sectional view taken along line 27A of FIG. 27.

FIG. 27B is an enlarged, fragmentary side view of a section of a corner edge of the shelf attachment devices shown in FIG. 27.

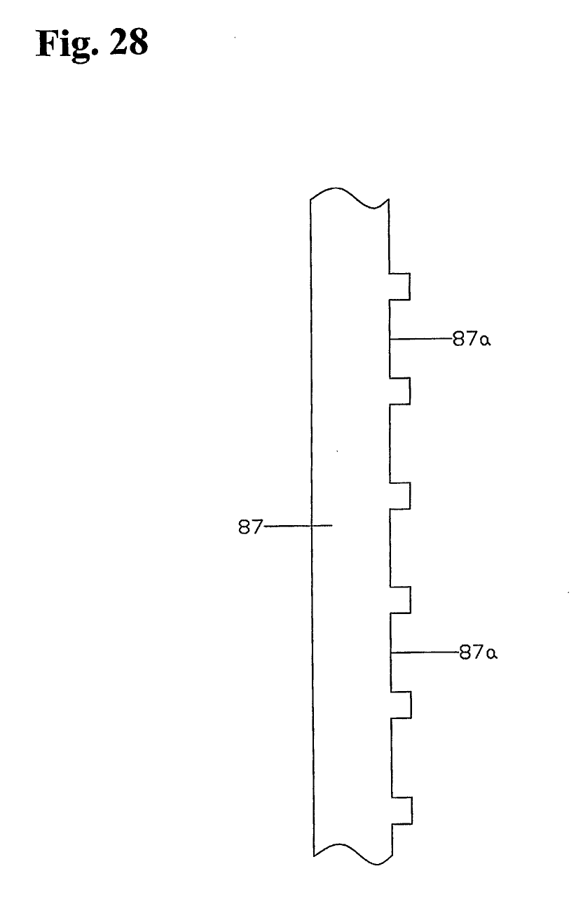

FIG. 28 is a cross-sectional view taken along line 28-28 of FIG. 27.

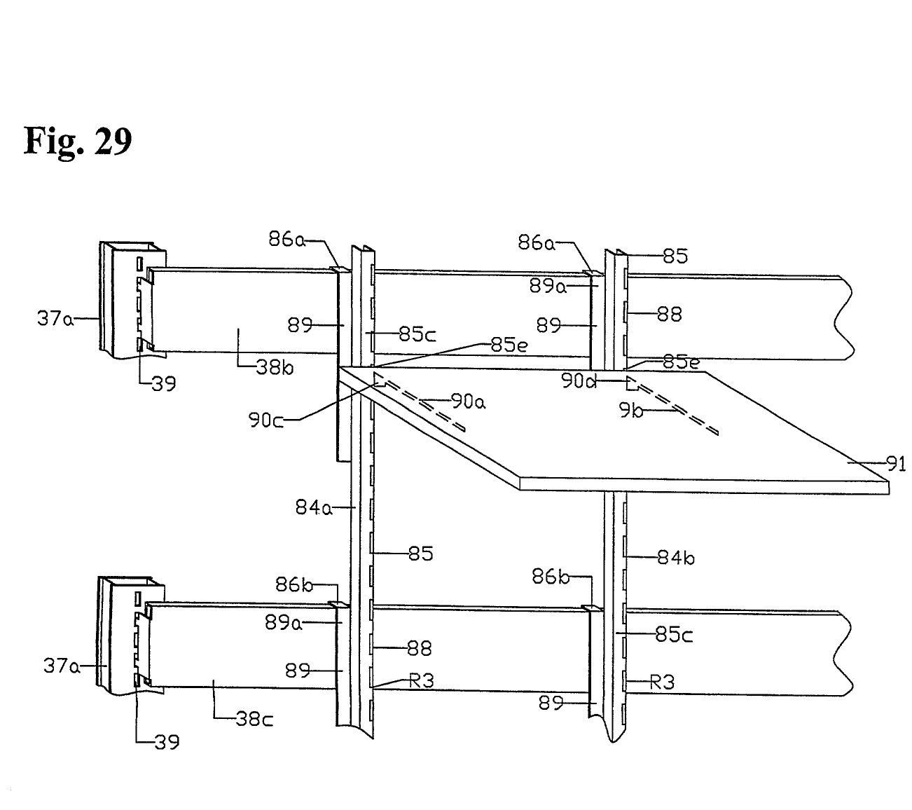

FIG. 29 is a perspective view, with sections broken away, of a pair of shelf attachment devices shown in FIG. 27 detachably connected to a pair of adjacent horizontal supports.

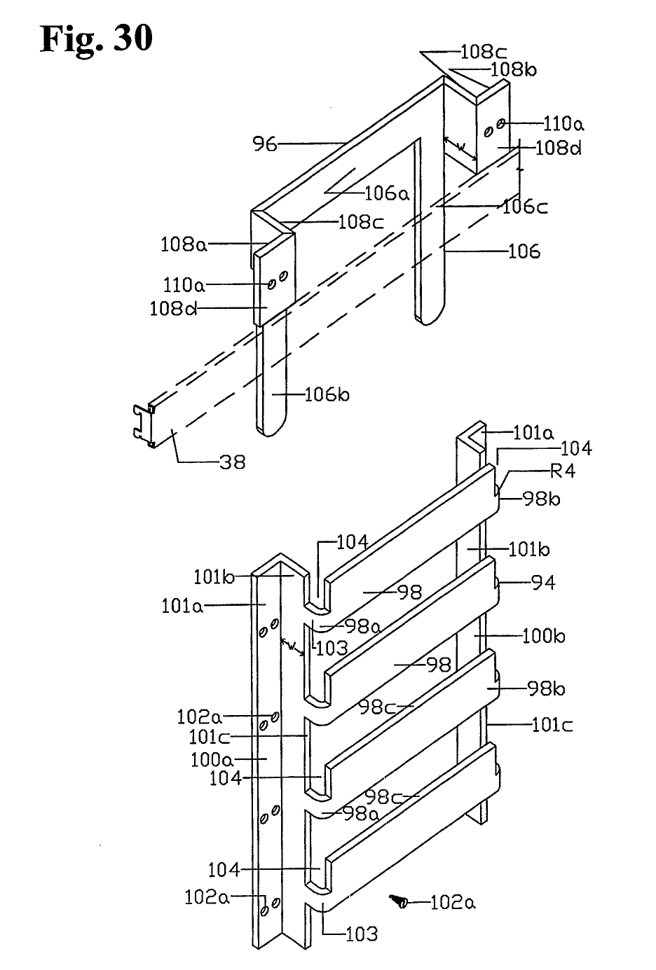

FIG. 30 is a perspective view of the shelf manager attachment of this invention including an intermediate connector mounted to a horizontal support.

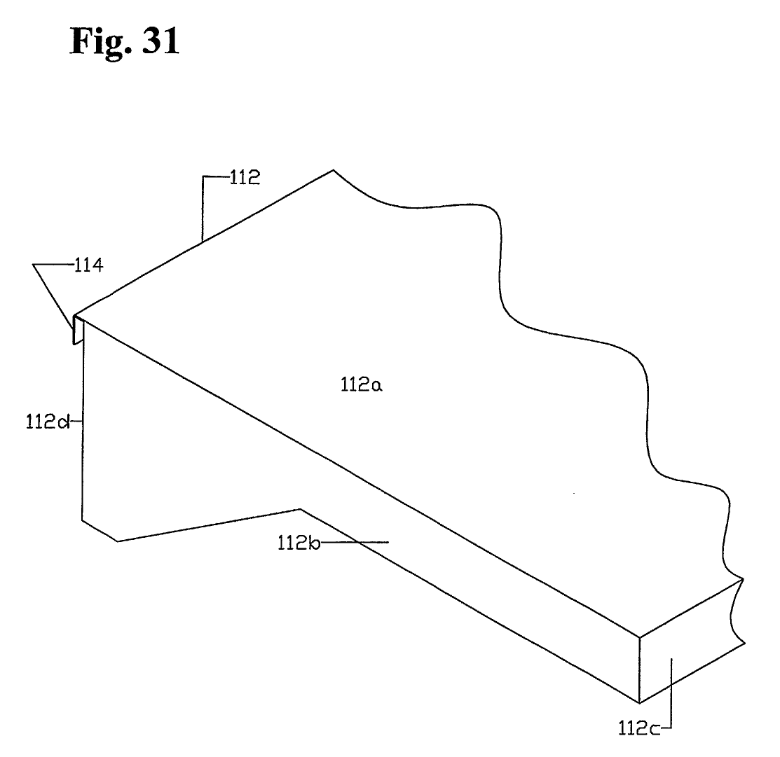

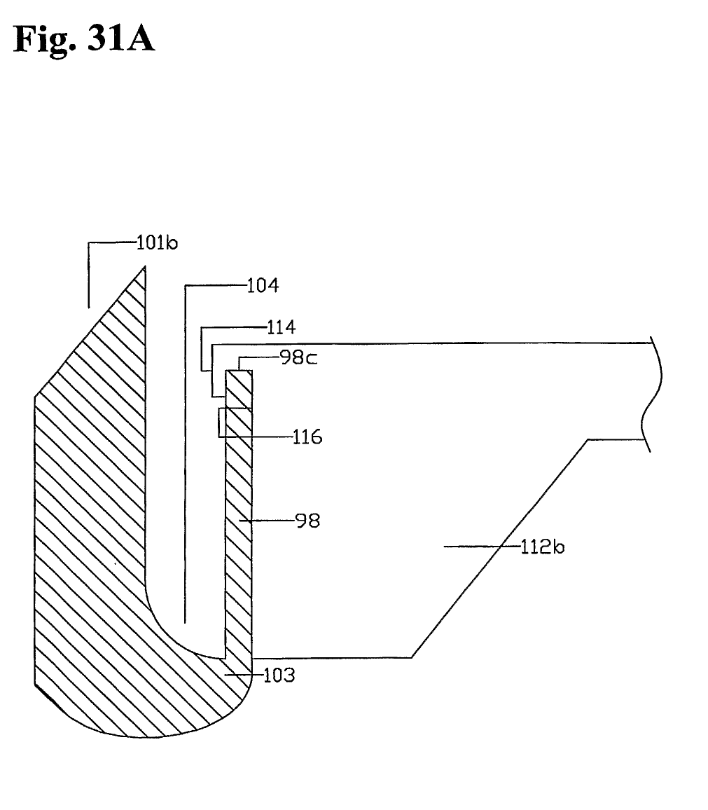

FIG. 31 is a perspective view of a shelf that is used with the shelf manager attachment shown in FIG. 30.

FIG. 31A is a fragmentary side view of the shelf shown in FIG. 31 attached to one support of the shelf manager attachment shown in FIG. 30.

### Version 2

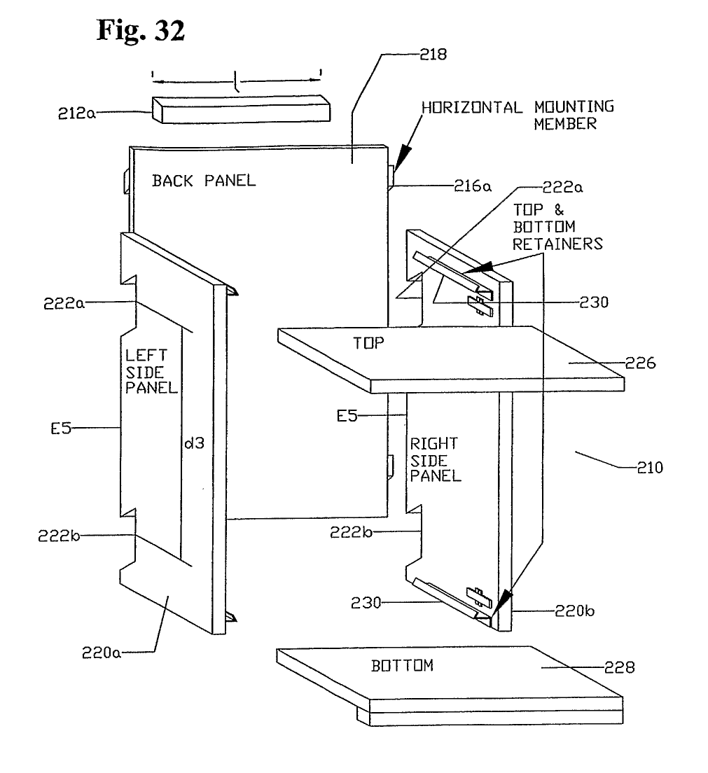

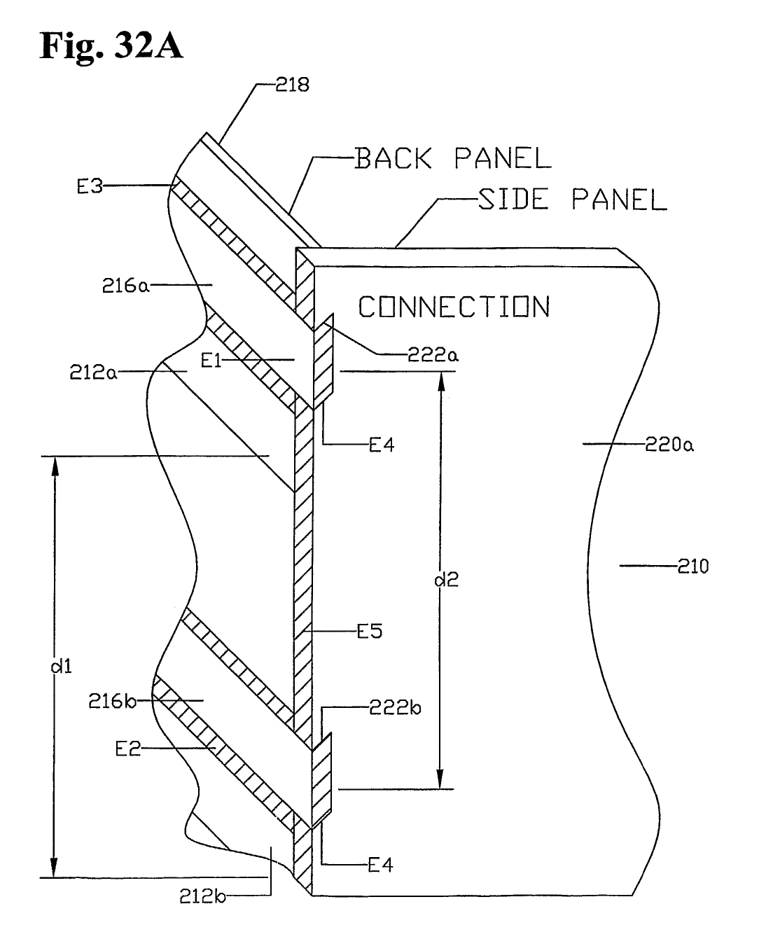

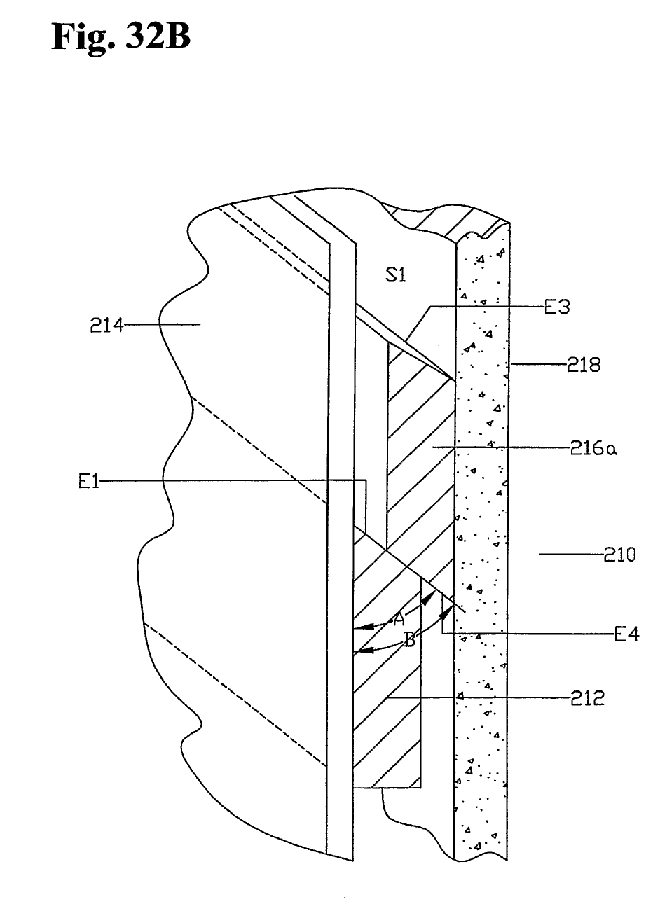

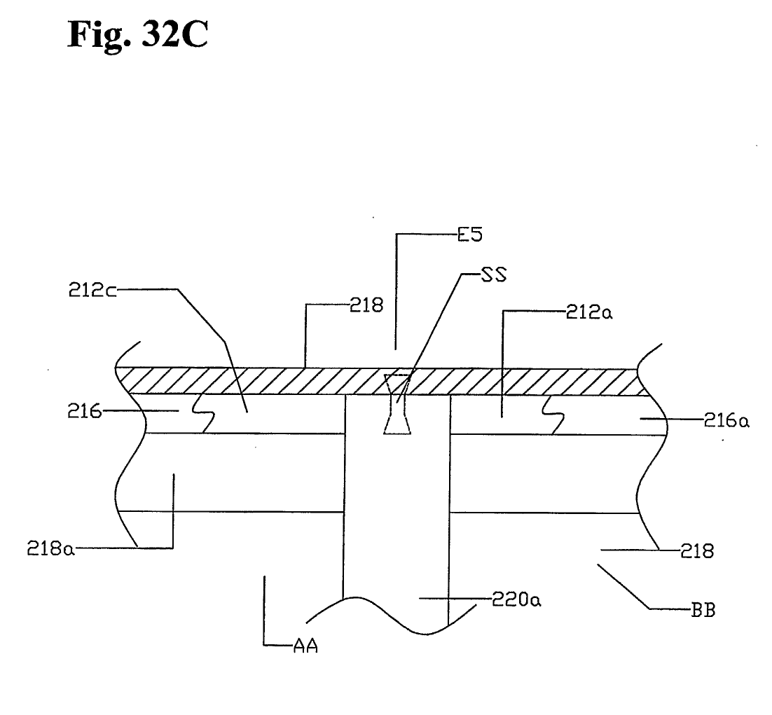

FIG. 32 is an exploded perspective view of an embodiment of the modular storage system of this invention that is adapted to be mounted to a wall.

FIG. 32A is a perspective view of the corner of the embodiment of the modular storage system shown in FIG. 32.

FIG. 32B is a perspective view, with sections broken away, of the embodiment of the modular storage system shown in FIG. 32 mounted to a horizontal cleat fixedly attached to the studs of a wall.

FIG. 32C is a plan view, with sections broken away, showing adjacent storage sections using a common side panel positioned between a pair of adjacent and spaced apart cleat members.

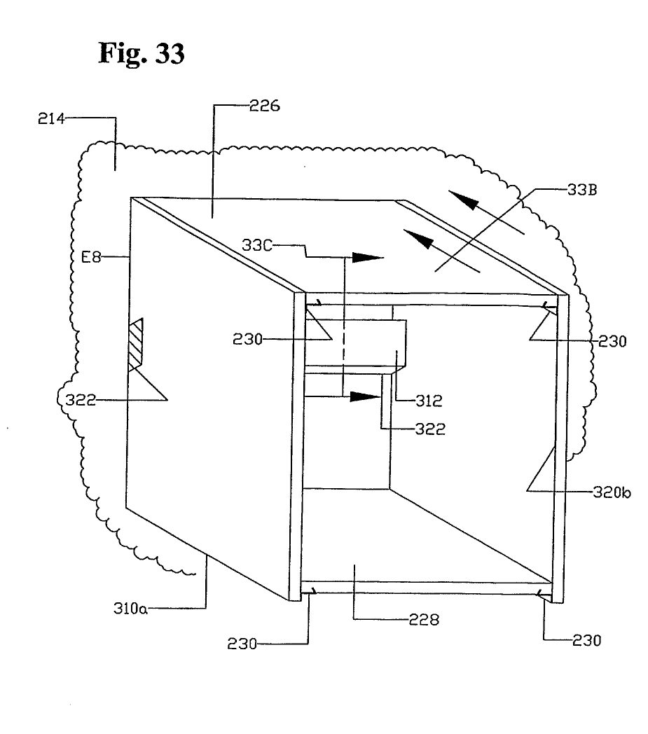

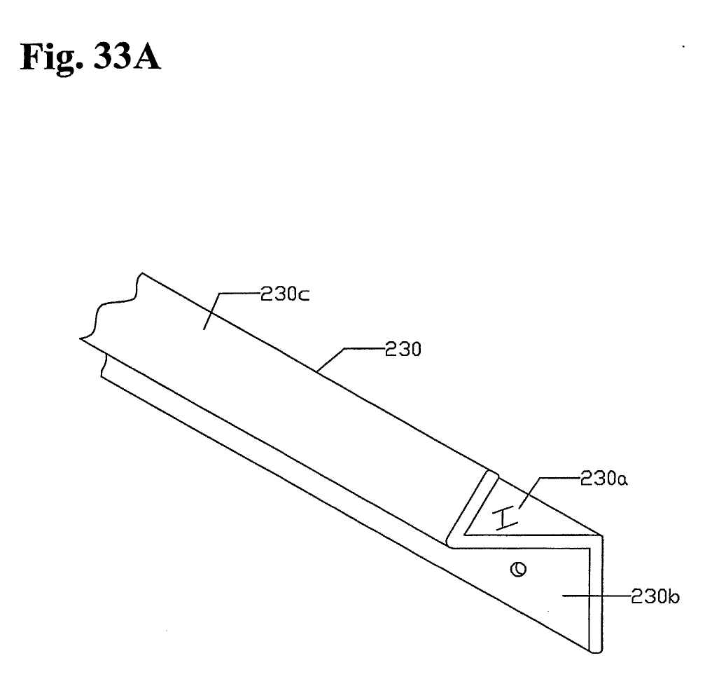

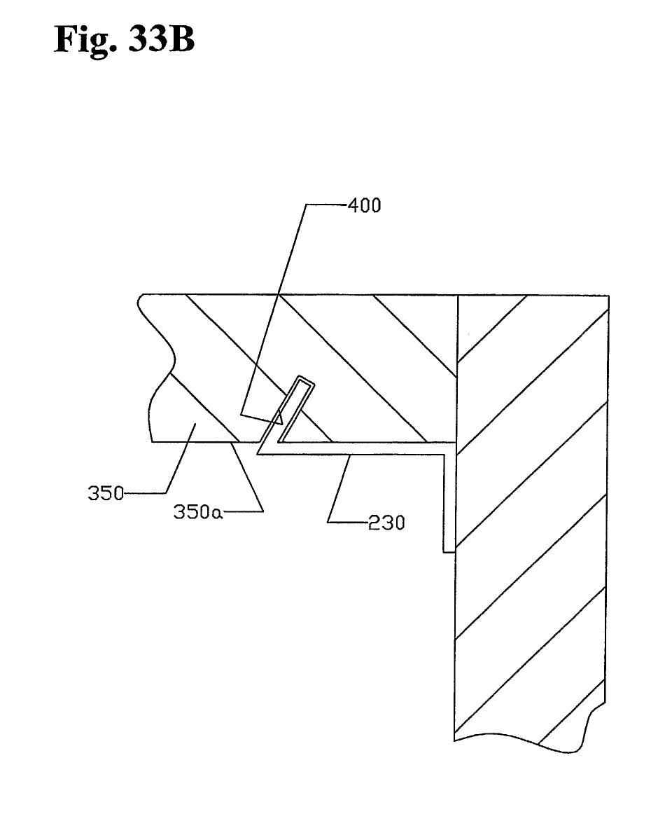

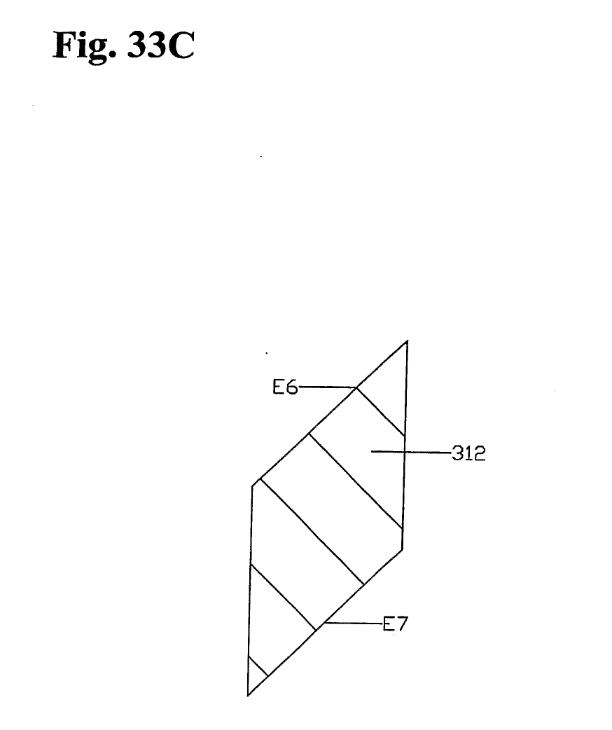

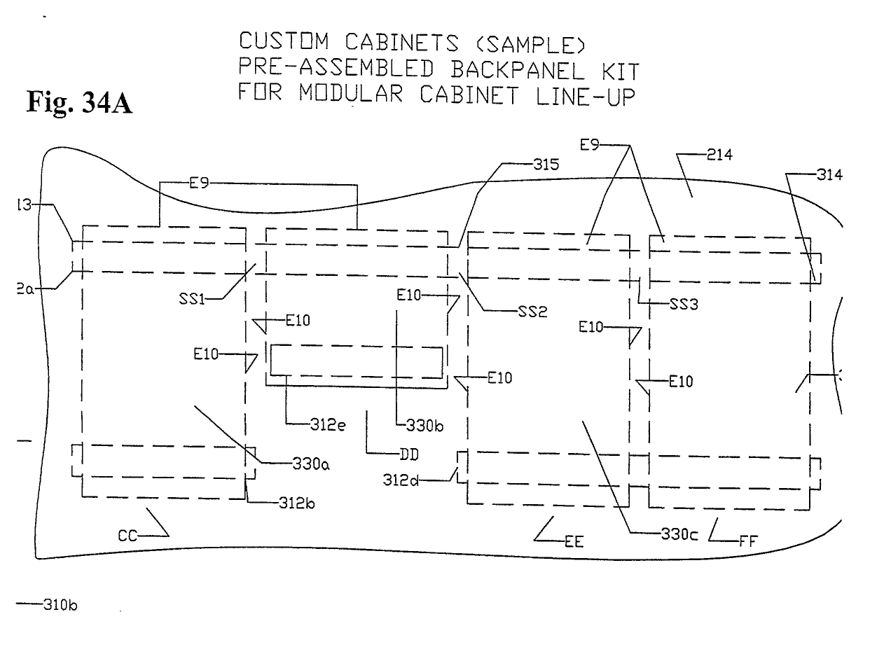

FIG. 33 is a perspective view of another embodiment of the modular storage system of this invention that is adapted to be mounted to a wall.

FIG. 33A is a perspective view of a retaining rail used in connection with the embodiments shown in FIGS. 32 and 33.

FIG. 33B is a cross-sectional view taken along line 33B-33B in FIG. 33.

FIG. 33C is a cross-sectional view taken along line 33C-33C in FIG. 33.

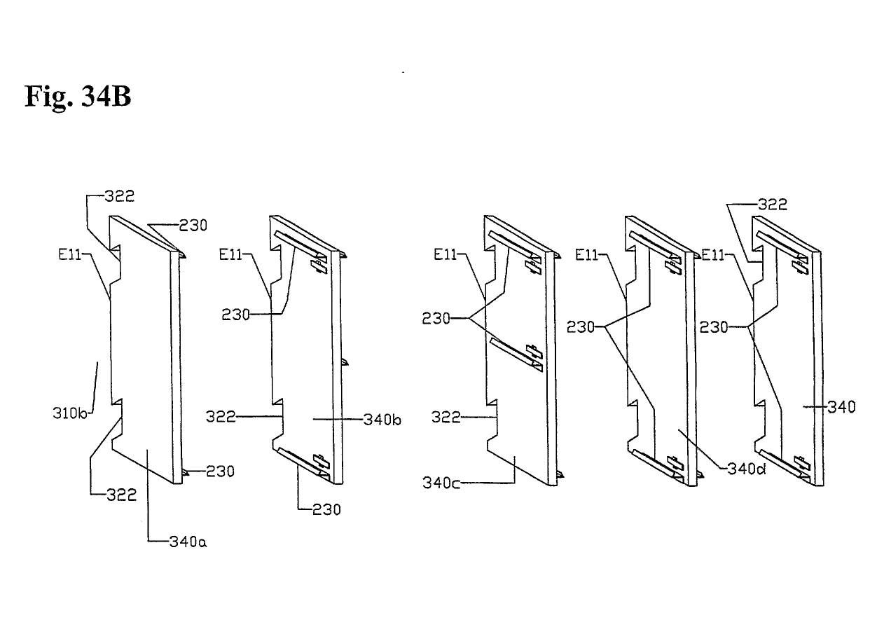

FIG. 34A is a front elevational view of a series of back panels mounted on a wall and positioned spaced apart to allow the side panels shown in FIG. 34B to be inserted between adjacent back panels.

FIG. 34B is a perspective view of a series of side panels positioned spaced apart, with individual side panels aligned with the ends or gaps between adjacent back panels shown in FIG. 34A.

### DETAILED DESCRIPTION OF SOME EMBODIMENTS OF THIS INVENTION

### Version 1

FIGS. 9, 10, 11 and 11A illustrate different embodiments of Version 1 of the modular storage system of this invention, namely, the system 10 (FIG. 9), the system 12 (FIG. 10), the system 14 (FIG. 11), and system 15 (FIG. 11A). In all these systems 10, 12, 14, and 15 at least some of system's components are connected directly or indirectly along vertical and horizontal directions, for example, using a conventional gondola 16 depicted in FIG. 3, which is a wall unit. Alternately, as depicted in FIGS. 2 and 8, at least some of system's components may be mounted to a wall 19 directly. In this later case, one type of a horizontal support may comprises at least a pair of adjacent horizontal boards 17a and 17b having their respective opposed ends 17a nailed, screwed or otherwise fixed between adjacent studs 23 (only one shown) of the wall 19. Each horizontal board 17a and 17b is slightly set off about ½ inch away from the wall 19 by a strip of plywood 21 to form a recess 21a. As will be apparently subsequently, the recess enables the appropriate panel clips (FIGS. 17, 17A, 17B, 18, 18A and 18B) of this invention to be used to connect rigidly an appropriate panel (FIGS. 14, 15, and 19) of this invention in a vertical orientation.

The system 10 includes a cabinet 18, shelving 20, a cubbyhole 22, scope bins 124, and gravity feed bins 126. The cabinet 18 avoids the racking problem without an anti-racking fifth element 36. The racking problem is illustrated in FIG. 1. A conventional cabinet is simply a box B with opposed parallel panels: a top panel 28, a bottom panel 30, a left hand end panel 32, and a right hand end panel 34. As shown in FIG. 1(C), without a back panel, or other type of rear fifth element 36, “racking” or sideways movement will occur when a lateral force as indicated by the arrow A is applied to the box B. In this invention, racking is avoided by rigidly attaching to a horizontal support a vertical panel such as the left hand (FIG. 20) and right hand (FIG. 20) end panels 32 and 34 designed in accordance with this invention. This horizontal support may be a rail member 38 (FIG. 12) of this invention, or, as shown in FIGS. 2 and 8, a pair of adjacent horizontal boards 17 (FIG. 8) nailed, or otherwise fixedly attached between adjacent wall studs 23. The advantage of using the rail member 38 is that it may be detachably connected to the vertical uprights of a conventional gondola 16 (FIG. 3).

In assembling the cabinet 18 in accordance with this invention at least one pair of panels are employed, for example, the right hand end panel 32 and the left hand end panel 34 (FIGS. 5 and 11A), or one of these end panels and a divider panel 40 (FIGS. 15 and 16). The appropriate two panels are selected on the basis of the type of shelving and/or cabinet structure being assembled. The selected two panels are spaced apart and detachably and rigidly connected to the support structure, either the horizontal rail member 38 or the horizontal board 17. As discussed subsequently in greater detail, the connection of the two panels to the horizontal support is accomplished using one or more appropriate panel clips of this invention, namely, a divider panel clip 42 or 42a (FIGS. 17 and 17A), a left hand end panel clip 44 or 44a (FIGS. 19 and 18B, and a right hand end panel clip 46 or 46a (FIGS. 18 and 18A). As subsequently discussed in detail, the assembly of a panel clip, panel, and horizontal support provide a rigid cantilever structure.

The rail member 38 of this invention as illustrated best in FIGS. 12 and 13 includes an elongated body 38b having opposed ends 33a and 33b. The body 38b has a generally C-shape cross-section as depicted in FIG. 13 with a central section 38c and a pair of opposed L-shaped legs 38d and 38e. This C-shape cross-section increases the rigidity and strength of the rail member 38. The length of the rail member 38 may vary and be customized for a specific situation or it may come in standard 3 or 4-foot lengths for use with standard vertical uprights of conventional gondolas. The width w₁ of the central section 38c may be important in some cases, for the wider the central section the greater its strength and the greater its surface area to assist in holding a panel rigidly in place to avoid racking.

Each opposed end 33a and 33b has thereat a connector element 35 adapted to interact with a vertical upright 37a or 37b, as the case may be, to connect detachably the rail member 38 between these vertical uprights. Each vertical upright 37a and 37b is a hollow tubular structure made of steel and having a rectangular cross-section. On a face F of each vertical upright 37a and 37b is a series of indexing sites in a row equally spaced apart a standard distance such as 1 inch from their centers. In this embodiment, the sites comprise rectangular shaped openings 39, typically having a length of ⅞ inch and spaced apart a distance of about ⅜ inch.

Each connector element 35 comprises a pair of prongs 35a and 35b substantially at a right angle with respect to the central section 38c of the body 38b. The prongs 35a and 35b of each pair are spaced apart a predetermined distance greater than the length of one indexing site, that is, the vertical length of an individual openings 39. In other words, one or more indexing sites are situated between the adjacent prongs 35a and 35b upon insertion of the individual prongs of each connector element 35 into a pair of openings 39 when connecting the rail member 38 between the vertical uprights 37a and 37b. Thus, each pair of prongs 35a and 35b is detachably connected to a pair of sites separated by at least one indexing site. In the embodiment illustrated, the prongs 35a and 35b are substantially flat and spaced apart a predetermined distance of about 1 inch from their centers. The rail member 38 may be made from a sheet of material that is cut and bent to form the shape of the rail member. For example, 14 gauge cold rolled steel may be used.

FIG. 16 shows the divider panel 40 being detachably connected to one of the horizontal rail members 38 by the divider panel clip 40. This clip 40 has a rear segment in the form of hook-shaped element 48 that fits snugly over a top edge 38a of the rail member 38 and a forward segment in the form of spaced apart parallel arms 50a and 50b that provide a panel connector element. The arms 50a and 50b are equal in length, each having a length from about 1 to about 2 inches. The outer edges 51a and 51b respectively of the arms 50a and 50b turn inward towards each other to form opposed fingers 51c and 51d that are at an acute angle that is greater than about 5° and less than 90°, with respect to their respective arms 50a and 50b. A tab 52 with a central aperture 54 extends outward from the edge 51a of the arm 50a. The aperture 54 is sized to receive a pin 56. This pin 56 has, as shown in FIG. 15, an outer portion 56a and an inner portion 56b. FIG. 17A depicts an alternate embodiment of the panel clip of this invention, the panel clip 42, which instead of using a tab with an aperture has a pair of parallel slots 58 in each of the arms 50a and 50b. FIG. 17B depicts another alternate embodiment of the panel clip of this invention, the panel clip 42a, which instead of using a tab with an aperture has pairs of holes 58a and 58b in each of the arms 50a and 50b.

Both the panel clips 42 and 42a may be made from a sheet of material, for example 14 gauge cold rolled steel. The metal sheet material is cut and bent to form either panel clips 42 and 42a. When made from metal sheet material, the hook-shaped element 48 includes: (a) a substantially top planar section 60, (b) an outer substantially planar section 62 integral with an outer end 60a of the top planar section and at substantially a right angle to this top section, and (c) an inner substantially planar section 64 integral with an inner end 60b of the top planar section and at substantially a right angle to the top planar section. The top planar section 60 has a width from about ½ to about 1½ inch and a length from about ¼ to about 1 inch and is substantially equal to the width of the edge 38a of the rail member 38. The outer and inner planar sections 62 and 64 each have a width substantially equal to the width of the top section.

The arms 50a and 50b are outwardly extending, planar, and each is integral with an edge of the hook element's inner planar section 64 and at substantially a right angle to this inner planar section. The arms 50a and 50b form an open mouth M with the fingers 51c and 51d forming spaced apart lips having planar surfaces 66. An inside lateral edge 68 of a divider panel 40 is interactive with the arms 50a and 50b. One or more divider panel clips 42 are manually slid along this lateral edge 68 with each arm 50a and 50b engaging one of the flat opposite sides 41a (FIG. 16) and 41b (FIG. 15) of the divider panel 40. As illustrated in FIG. 16, when the aperture 56 in the tab 52 of a divider panel clip 42 is in registration with a selected opening 72 in a side 41a or 41b of the divider panel 40, a pin 56 is inserted through the aperture 56. The pin 56 has its outer portion 56a engaging the tab 52 in the clip 42 and its inner portion 56b inserted into an opening 72 in a side 41a or 41b of the divider panel 40.

As illustrated in FIG. 16, the divider panel 40 may be held upright in a vertical orientation by a single divider panel clip 42 if this panel is relatively short, for example having a length of about 36 inches or less. But in many modular storage systems of this invention where longer divider panels 40a are employed as shown in FIG. 16A, two divider panel clip 42b and 42c are used to prevent a long divider panel 40a from torquing or twisting. The clip 42b is connected to an upper horizontal orientated rail member 38b and the clip 42c is connected to an adjacent, lower, horizontal orientated rail member 38c. Consequently, the two panel clips are spaced apart along an inside lateral edge 68 of the long divider panel 40a. The arms 50a and 50b of each of these divider panel clips 42b and 42c orient the panel 40a vertically and hold the panel 40a rigidly so that the panel does not rotate either clockwise or counter-clockwise or pivot to the right or the left towards the rail members 38b and 38c.

The divider panel clips 42, 42b and 42c are each configured to be interactive with both sides 41a and 41b of a divider panel 40 to which it is to be connected. Each side 41a and 41b of the divider panels 40 and 40a is planar and includes a pair of spaced apart longitudinally extending parallel grooves 70a and 70b that are at an acute angle that is greater than about 5° and less than 90°, with respect to the side 41a or 41b, as the case may be. The grooves 70a and 70b point away from each other. The finger 51c and groove 70a are at substantially the same acute angle and the finger 51d and groove 70b are at substantially the same acute angle. Nearby each groove 70a and 70b is a series of substantially longitudinally extending openings 72 in a row R1 or R2. Each row R1 and R2 of openings 72 is substantially parallel to its nearby groove. The rows R1 and R2 are also parallel to each other.

During assembly of one of the embodiments of the modular storage system of this invention, the one or more divider panel clips 42 are detachably connected to the lateral edge 68 of the divider panel 40. A divider panel clip 42 is first placed over or under the divider panel 40 to which it is to be connected with the fingers 51c and 51 d aligned with the grooves 70b on the opposed sides 41a and 41b of the divider panel. It is then slid manually along the lateral edge 68 with the fingers 51c and 51d being pushed into and along the grooves 70b. The divider panel clips 42 are hung on the rail members 38 or boards 17 as discussed above and the vertical location of the divider panel 40 is adjusted until a desired vertical position is attained. Then a pin 56 is inserted through the aperture 54 in the tab 52 of the clip 42. The pin's outer portion 56a engages the tab 52 in the clip 42 in the clip 42a and the pin's inner portion 56b is inserted into an opening 72 in a side 41a or 41b of the divider panel 40, as the case may be. This locks the divider panel 40 in the desired vertical position until disassembled. When a divider panel clip 42a shown in FIG. 17A is used, the pin 56 extends through the slot 58 into the selected opening 72.

Each end panel clip 44 and 46 is configured to be interactive with only one side of a panel and a rear lateral edge thereof to which it is to be connected. As shown in FIGS. 18 and 19, the right hand end panel clip 46 has parts that similar in shape to the divider panel clip 42 and it may also be made from sheet material and cut and bent into shape like the divider panel clip. The right hand end panel clip 46 has a hook shaped element 48 as discussed above, one long arm 46a that is essentially identical to the arm 50a of the divider panel clip 42, and one short straight arm 46b, terminating in a straight edge 46c that is at a right angle the top planar section 60 of the hook shaped element. The long arm 46a terminates in the finger 51c and has the tab 52 with the aperture 54 therein for a pin 56.

The right hand end panel 34 has a opposed planar sides with only one side S1 including a pair of spaced apart longitudinally extending parallel grooves, only groove 70b shown, that are at an acute angle that is greater than about 5° and less than 90°, with respect to the side S1. The finger 51c and groove 70b are at substantially the same acute angle. Nearby each groove is a series of substantially longitudinally extending openings 72 in a row R1 (only one row shown). Each row of openings 72 is substantially parallel to its nearby groove and the rows are also parallel to each other. Along the inner lateral edge 69 of the right hand end panel 34 is a longitudinally extending channel 74 into which the straight edge 46c of the short arm 46b is inserted during assembly. Consequently, upon connecting the right hand end panel 34 to the rail member 38 using the right hand end panel clip 46 and inserting a pin 56 into the aperture 54 and an aligned opening 72, the right hand end panel is held rigid in place and will not rotate or pivot.

The left hand end panel clip 44 as shown in FIG. 19 is a mirror image of the right hand end panel clip 46. This left hand end panel clip 44 connects the rail member 38 or other horizontal support to the left hand end panel 32 (FIG. 14) like that of the right hand end panel clip 46. Its long arm 44a is essentially identical to the arm 50b of the divider panel clip 42 and includes the finger 51d. The left hand end panel clip 44 also has a parallel short arm 44b. The left hand end panel 32 includes in its inside surface 32a the parallel rows R1 and R2 of openings 72 next to the parallel grooves 70a and 70b and its lateral rear edge 69a has a longitudinally extending channel 74 that receives the short arm 44b upon assembly of the left hand end panel clip 44 and the left hand end panel 32.

After the left hand end panel 32 and right hand end panel 34 have been rigidly attached to a horizontal support as depicted in FIGS. 5 and 11A, horizontal shelves 76 are detachably connected between these panels using the shelf clips 78 of this invention shown in FIGS. 20 through 25. These shelf clips 78 are also used with the divider panel 40. Alternately conventional fixtures may also be used, for example, the panels 32, panel 34, and 40 may use KV™ standards and associated clips. A top panel 28 and a bottom panel 30 may also be detachably connected between the left hand end panel 32 and right hand end panel 34 as shown in FIG. 6 to form a cabinet 75 without an anti-racking back panel. FIG. 11A illustrates a gondola 16a with shelves 76 on both sides with a peg-board 16b mounted between the vertical uprights. This peg-board 16b does not function as a fifth anti-racking element and is used in the conventional manner to hang items on it. The shelf clips 78 are adapted to connect detachably at selected positions to any vertical panel of this invention by partial insertion into either the groove 70a or 70b and held in position by a pin 56.

Referring to FIGS. 22 through 23, each individual shelf clip 78 includes a pair of substantially planar finger elements 78a and 78b that are a substantially identical in configuration. The finger elements 78a and 78b intersect along a line B to form a substantially right angle with respect to each other. The finger element 78a is above the finger element 78b and they are symmetrical. Another substantially planar finger element 78c projects outward from the intersection of the finger elements 78a and 78b to form angles c and d greater than 90° with respect these finger elements 78a and 78b. The angles c and d may be greater than 90° and less than 180°. These angles c and d are chosen so that upon inserting the finger element 78c into, for example the groove 70a as illustrated in FIG. 20, an inner side 79 (FIG. 23) of the finger element 78b bears against and is substantially flush with the inside surface 32a of the panel 32. Because the finger elements 78a and 78b are at a right angle, the finger element 78a is at a right angle to the inside surface 32a upon connection of a shelf clip 78 to a vertical panel of this invention. Each finger element 78a and 78b has a hole 80 therein to be aligned with an opening 72 in a side of the vertical panel. To hold the shelf clip 78 in position, a pin 56 is inserted through the hole 80 and into an aligned opening 72.

As depicted in FIG. 25, each finger element 78a and 78b has an outer raised tip 81. The finger elements 78a and 78b are positioned relative to each other with their respective tips 81 pointing in opposite directions. The raised tips 81 are each adapted to fit into a drilled cavity 77a or 77b in an underside 76a of a shelf 76 made in accordance with this invention. An edge 78d of the fingers 78a and 78b between the tip 81 and the finger element 78c fits in an elongated portion of the cavity 77a or 77b when connected thereto. The cavities 77a or 77b are both adjacent outer edges E1 (only one shown) of each shelf 76. The cavities 77a and 77b are substantially identical. Each has a cylindrically shaped portion inwardly displaced from an edge of the shelf 76 with an open end in the shelf's underside 76a and an open end 77c along this edge. As illustrated best in FIG. 25, the cavities 77a and 77b are positioned so that upon attachment of a shelf 76 to a vertical panel, the open end 77c of both cavities is aligned with the groove 70a and 70b.

Due to the unique configuration of the shelf clip 78 of this invention, it is simply inverted when it is to be connected to the groove 70b. Thus, the shelf clip 78 may be used with any of the panels of this invention even though the panel may be a divider panel 40, a left hand end panel 32 or a right hand end panel 34. Similar to the other clips of this invention, the shelf clip 78 may be made from a sheet of material that is cut and bent to form the shelf clip, for example 12 gauge cold rolled steel. Consequently, the finger elements 78a, 78b, and 78c are integral with each other. The finger elements 78a and 78b each have a width w₂ from about ¼ to about 3 inches and a height of less than about ¾ inch. The finger element 78c has a width usually less than the width w₂ of the finger elements 78a and 78b and a length about twice that of the height of the finger elements 78a and 78b or about 1½ inches. In other words, the finger element 78c has a width substantially equal to the combined width of the finger elements 78a and 78b.

An optional modular component of this invention is a shelf attachment device 84 shown in FIGS. 26 through 29. The shelf attachment device 84 has an elongated body 85 with at least one segment, for example a hook member 86, for detachably connecting the device to a horizontal support such as the rail member 38. There may be a series of these hook members 86 aligned along one side of the body 85. These hook members 86 comprise planar pieces and are very similar in shape to the hook-shaped elements 48 of the of the panel clips discussed above. This enables the hook members 86 to be placed over the top edge 38a of a rail member 38 to mount the shelf attachment device 84 securely, but detachably, to the rail member or other horizontal support.

As best shown in FIG. 27, the body 85 of the shelf attachment device 84 has a substantially U-shaped cross section with a pair of parallel legs 85a and 85b connected by a front segment 85c to form the corner edges 85d and 85e. The outer end of the one leg 85a has a plurality of spaced flanges 89 along this leg at a right angle thereto. There is a hook member 86 at an outer end 89a of each flange 89. The shelf attachment device 84 like the modular clips of this invention as discussed above may be made from a sheet of material that is cut and bent to form the device. Thus, the legs 85a and 85b, front segment 85c, and flange 89 are planar segments at right angles to adjoining parts. As shown in FIG. 28, a reinforcing bar 87 with U-shaped notches 87a along an edge may be used to enhance the strength of the shelf attachment device 84. This bar 87 is spot welded in place on the inside of the front segment 85c.

Along the corner edge 85e is a series of indexing sites positioned in a row R3 in an equally spaced apart sequence. Usually, through not required, the sites in the row R3 are positioned essentially like the positions of the openings 39 along the vertical upright 37a. The row R3 of the sites comprises essentially identically shaped openings 88 having an L-shaped cross-section with legs 88a and 88b at a right angle with respect to each other. As shown in FIGS. 27A and 27B, each opening 88 has a longitudinal length 1₁ of about ⅞ inch, and the legs 88a and each have a length 1₂ and 1₃ respectively of about 3/16 inch. These opening 88 are spaced apart a distance from about 1 inch on their centers. As illustrated in FIG. 27A, when the reinforcing bar 87 is used, its notches 87a are sized and positioned to be aligned with the opening 88 in the corner edge 85e. The corner edge 85e is substantially vertically orientated upon connection of the shelf attachment device 84 to a horizontal support.

As illustrated in FIG. 29, a pair of the shelf attachment devices 84a and 84b is mounted on a pair of adjacent horizontal rail members 38b and 85c. The hook members 86a of the devices 84a and 84b grasp the rail member 38b and the hook members 86b of the devices 84a and 84b grasp the rail member 38c. The shelf attachment devices 84a and 84b are now aligned parallel to each other and are vertically oriented. They are not in a fixed position, however, and may be moved laterally along the rail members 38b and 38c to adjust the distance between them as desired. A pair of conventional brackets 90a and 90b shown in phantom lines may now be attached to each shelf attachment device 84a and 84b by inserting the brackets' respective connector ends 90c and 90d into the L-shaped openings 88 in each device that are in line with each other. A conventional shelf 91 may now be placed on the brackets 90a and 90b.

FIG. 30 illustrates another optional modular component of this invention: a shelf manager attachment 94 that enables a user to move shelves laterally. This shelf manager attachment 94 is mounted to a horizontal support such as the rail member 38 (shown in phantom lines in FIG. 30) using an intermediate connector 96.

The shelf manager attachment 94 has a latter-like configuration and includes a series of parallel planar supports 98 in a row R4 connected between a pair of L-shaped side plates l00a and 100b. The planar supports 98 are spaced apart usually from about ¼ to about 2 inches, enabling a viewer to see through the shelf manager attachment 94. Each side plate l00a and l00b has a planar leg 101a and a planar leg 101b at a right angle to each other. The legs 101b are of equal width from about ⅛ to about 1 inch. There are spaced apart holes 102 along the length of each of the legs 101a (holes 102 only shown in one leg 101a), enabling metal screws 102a or other type of fasteners to pass through these holes for connecting the shelf manager attachment 94 to the intermediate connector 96. The opposed ends 98a and 98b of each support 98 are attached to the outer ends of the legs 101b by a narrow section 103. Thus, a gap 104 having a U or J shape is created between the backside of each support 98 and an outer edge 101c of the legs 101b.

The intermediate connector 96 includes a U-shaped planar central body 106 with a central planar element 106a having downwardly pointing, elongated planar legs 160b and 106c when this intermediate connector is mounted on a rail member 38. A pair of outwardly projecting L-shaped members 108a and 108b is attached to the opposed ends of the central planar element 106a. Each L-shaped member 108a and 108b includes a pair of planar arms 108c and 108d at a right angle to each other. The front face 110 of each arm 108d has holes 110a therein that receive the screws 102a upon attaching the shelf manager attachment 94 to the intermediate connector 96. Upon assembly of the manager attachment 94 and the intermediate connector 96, a structure is formed with one or more hook-type segments for detachably connecting the shelf manager attachment 94 to a horizontal support member such as the rail member 38. The arms 108c are equal in width and approximately equal to the width w of the top edge 38a of the rail member 38. Consequently, the assembled manager attachment 94 and intermediate connector 96 fits snugly over the rail member 38 to which it is being detachably connected.

The shelf 112 shown in FIG. 31 has a flat, planar top surface 112a and, extending downward at a right angle to the top surface 112a, planar right hand and left hand sides 112b (the right side is not shown) and a front side 112c. Along a rear side 112d is a planar lip 114 offset from the rear side a distance d approximately equal to the thickness t of the support 98. This offset lip 114 thus provides a narrow space 116 into which the upper edge 98c of the support 98 is inserted to attach the shelf 112 to the shelf manager attachment 94. This manner of detachably connecting the shelf 112 to the support 98 allows a user to move the shelf laterally to a selected horizontal position as desired. Moreover, the legs 101b, in effect, reduce the shelf space available. This is desirable in situations where the user wishes to reduce the inventory stored on shelves. For example, vitamin bottles are usually small; so many such vitamin bottles are stored on conventional shelves, sometimes for an undesirably long duration. Using the shelf manager attachment 94 of this invention thus reduces inventory.

Like most of the other components of this invention, the shelf manager attachment 94, intermediate connector 96, and shelf 112 may be made by cutting and bending a sheet of material such as 14 gauge cold rolled steel. All such metal components may be powder coated with plastic particles that are melted and cooled to form a protective film covering the surfaces of the components.

### General

The components of this invention discussed above, including the vertical panels 32, 34, 40, panel clips 42, 44 and 46, shelf clips 78, and shelves 76 of this invention, enable a user to create a modular storage system with one or more custom designed cabinets and shelving depicted in FIGS. 9, 10, 11, and 11A. These modular components may be arranged in a countless number of ways to utilize the available space to display and/or store merchandise and/or other items in the most cost effective and efficient manner. The shelves may be adjustable both vertically and laterally. The cabinet 18 may have a non-load bearing backing, one or more doors, a doorframe for the door, one or more drawers, and a drawer front a drawer. A modular storage system of this invention may include one or more face frames, molding, electrical lights, and signs, cubbyholes, and bins. Several types of brackets 118, (FIG. 4), 120 (FIG. 4A), and 122, each a with hook member H1 for attaching these brackets to a horizontal support such as the rail member 38 or the boards 17a or 17b , may be used with modular storage system of this invention. The brackets 118 and 120 are used to support a shelf. The bracket 122 is used to support bins, either a scope bin 124 or a gravity-feed bin 126 (FIGS. 9, 10 and 11).

In some cases, especially making a cabinet as a portion of the modular storage system of this invention, it may be desirable to fix the components in position with screws, mechanical couplers, or other fasteners rather that mounting them to be detached. Also, conventional shelf mounting fixtures and other conventional attachments may be used in conjunction with the vertically panels of this invention.

### Version 2

One embodiment of Version 2 is shown in FIGS. 32 through 32C, namely, the modular storage system 210, and another embodiment of Version 2 is shown in FIGS. 33 through 34A, namely, the modular storage system 310.

As illustrated in FIG. 32A, the modular storage system 210 includes a pair of substantially horizontally oriented cleat members 212a and 212b (shown in phantom in FIG. 32A) and a pair of substantially vertically oriented side panels 220a and 220b. The cleat members 212a and 212b are fixedly attached to a vertical wall 214 (FIG. 32B) using nails, screws or other fastener means (not shown). A pair of substantially horizontally oriented mounting members 216a and 216b are spaced apart vertically and fixedly attached to an exterior surface S1 (FIG. 32B) of a back panel 218 using nails, screws or other fastener means (not shown). The mounting members 216a and 216b are substantially in registration.

The cleat members 212a and 212b are spaced apart vertically a distance d₁ substantially equal to the distance d₂ between the mounting members 216a and 216b, but the cleat members and mounting members are offset relative to each other. The cross-sectional configurations of each cleat member 212a and 212b are substantially identical. Each cleat member 212a and 212b has an upper horizontal edge E1 and E2 respectively forming an acute angle A with respect to the wall 214. This acute angle A (FIG. 32B) may vary between about 30 and about 60 degrees. The mounting members 216a and 216b each have upper and lower substantially horizontal edges E3 and E4 and a predetermined cross-sectional configuration, for example, rhomboidal. The lower edge E4 of the mounting member 216a engages the upper edge E1 of the cleat member 212a and the lower edge E4 of the mounting member 216b engages the upper edge E2 of the cleat member 212b, upon mounting the back panel 218 as shown in FIG. 32B. The lower edges E4 of both mounting members 216a and 216b each have an acute angle B (FIG. 32B) substantially equal to the acute angle A of the cleat member upper edge being engaged. The cleat members 212a and 212b, which typically are of equal length, each have a length 1 that is less than the distance d₄ between the side panels 220a and 220b.

The side panels 220a and 220b each have an inner edge E5 with a pair of cut-a-way sections 222a and 222b. These cut-a-way sections 222a and 222b each have a configuration substantially corresponding to the cross-sectional configuration of the mounting member that they engage, in this case rhomboidal-like. The individual sections of each pair of cut-a-way sections 222a and 222b are spaced apart a distance d₃, which is substantially equal to the distance d₂ between the mounting members 216a and 216b. The individual cut-a-way section 222a is seated on the mounting member 216a and the individual cut-a-way section 222b is seated on the mounting member 216b. The positions of the cut-a-way sections 222a and 222b along the edge E5 of each side panel 220a and 220b is such that, upon mounting, the side panels are in registration with each other. The side panels 220a and 220b are spaced apart a predetermined distance horizontally along the pair of mounting members 216a and 216b and are each substantially vertically oriented and extend outward from the wall 214 at substantially a right angle. Horizontally oriented top and bottom shelf members 226 and 228, respectively, extend between the side panels 220a and 220b and are supported by opposed retainers 230 that fit into grooves in the side panels and shelf members. These retainers will be discussed subsequently in greater detail in connection with the modular storage system 310.

As depicted in FIG. 32C, an alternate embodiment of the modular storage system 210 includes a pair of adjacent storage sections AA and BB. The cleat member 212c of the storage section AA and the cleat member 212a of section BB are aligned and spaced apart to provide a space SS to enable the side panel 220a to be shared in common between the sections AA and BB. The mounting member 216 of section AA overlies and rests on the upper edge of the cleat member 212c and the mounting member 216 of section BB overlies and rests on the upper edge of the cleat member 212a. The space SS between the opposed ends of the cleats members 216 and 216a is about equal to the thickness of the common side panel 220a, and consequently is of sufficient width to enable the edge E5 of the common side panel to fit snugly between the opposed ends of the adjacent and aligned cleat members 216 and 216a.

In assembling the modular storage system 210, typically the cleat members 216a and 216b are first attached to the vertical wall 214 and positioned to receive the mounting members 216a and 216b. Typically, the mounting members 216a and 216b and back panel 218 are prefabricated with the mounting members correctly positioned and spaced so that upon assembly with the cleat members 216a and 216b the back panel with be positioned to form a box-like structure upon connecting the side panels 220a and 220b to the mounting members. A kit including the mounting members 216a and 216b attached to the back panel 218 and the side panels 220a and 220b is one feature of this invention. The cleat members 216a and 216b may be included in such a kit, but this is optional.

As depicted in FIGS. 33 through 34B, the modular storage system 310 does not use a cleat member. Instead, it employs one or more mounting members fixedly attached directly to the vertical wall 214. The modular storage system 310 may or may not employ a back panel or panels.

One embodiment of the modular storage system 310, namely the system 310a shown in FIG. 33, has a single horizontal mounting member 312 fixedly attached to the vertical wall 214. This mounting member 312 has a predetermined cross-sectional configuration with a pair of opposed horizontal edges E6 and E7 (FIG. 33C), each edge forming a predetermined angle with respect to the wall 214. These angles may be the same or different. Most usefully, the cross-sectional configuration of the mounting member 312 is rhomboidal.

At least one pair of side panels 320a and 320b are mounted directly on the mounting member 312. Each side panel 320a and 320b has an inner edge E8 with at least one cut-a-way section 322 having a configuration corresponding to the cross-sectional configuration of the mounting member. For example, the cross-sectional configuration of the cut-a-way section 322 may be substantially rhomboidal and is position along the edge E8 so that the side panels 320a and 320b will be in registration upon assembly. The side panels 320a and 320b are each seated on the mounting member 312 with the cut-a-way sections 322 of each side panel and the mounting member fitting snugly together. The side panels 320a and 320b are spaced apart horizontally along the mounting member 312 and are each substantially vertically oriented and each extend outward from the vertical wall 214 at substantially a right angle. One or more substantially horizontally oriented members, for example, the top shelf member 226 and bottom shelf member 228, extend between the side panels 320a and 320b and are support by the retainers 230.

A back panel may be inserted into the interior of the box-like structure formed upon assembly of the side panels 320a and 320b and shelf members 226 and 228, or as illustrated, no back panel need be employed.

Another embodiment of the modular storage system 310, namely the system 310b shown in FIG. 34A and 34B includes a number of storage sections CC, DD, EE, and FF formed by a plurality of side panels 340a, 340b, 340c, 340d, and 340e. Each of these side panels 340a, 340b, 340c, 340d, and 340e have inner edges E11 with cut-a-way sections 322 like those discussed above to fit snugly on a mounting member. This modular storage system 310b has one substantially horizontal mounting member 312a fixedly attached to the vertical wall 214 and a plurality of lower substantially horizontal mounting members 312b, 312c, and 312d fixedly attached to the vertical wall 214. The mounting member 312b is positioned under the left portion 313 of the mounting member 312a, the mounting member 312d is positioned under the right portion 314 of the mounting member 312a, and the mounting member 312c is positioned under the central portion 315 of the mounting member 312a. A plurality of back panels 330a, 330b, 330c, and 330d are fastened to the mounting members 312a, 312b, 312c, and 312d with their respective top edges E9 aligned and back panels having adjacent parallel edges E10 spaced apart to provide spaces SS1, SS2, and SS3 into which respectively fit the inner edges E11 of side panels 340b, 340c, and 340d,

One or more horizontal shelf members 350 such as shown in FIG. 33B may be attached to adjacent side panels, for example, the panels 340d and 340c using the retainers 230. Each retainer 230 includes a right angle junction formed by elongated support members 230a and 230b and an elongated edge element 230c that forms an acute angle with the member 230a. There is an angular, elongated groove 400 in the underside 350a of the of the shelf members 350 into which the elongated edge element 230c is inserted during assembly. The top surface T of the support member 230a abuts the underside 350a of shelf member 350.

### SCOPE OF THE INVENTION

The above presents a description of the best mode contemplated of carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above which are fully equivalent. Consequently, it is not the intention to limit this invention to the particular embodiments disclosed. On the contrary, the intention is to cover all modifications and alternate constructions coming within the spirit and scope of the invention as generally expressed by the following claims, which particularly point out and distinctly claim the subject matter of the invention:

1. A modular storage system where at least some of its components are connected directly or indirectly along vertical and horizontal directions to a support structure, said system comprising,
at least one pair of panels, said panels being spaced apart and connected to the support structure by a plurality of panel clip members,
each panel clip member including one segment connected to the support structure and another segment connected to a panel,
each said panel clip members orienting the panel to which it is connected substantially vertically and extending outward from the support structure at substantially a right angle, and
at least one substantially horizontally oriented member extending between the panels.

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. A modular storage system comprising
at least one pair of spaced apart rail members, each rail member mounted on a substantially vertically oriented support structure in a substantially horizontal orientation,
at least one pair of panels space apart and detachably connected to the rail members by a plurality of panel clip members,
each panel clip member having a predetermined configuration that orients the panel to which it is connected substantially vertically and to extend from the support structure at substantially a right angle, and
at least one shelf member extending between the pair of panels in a substantially horizontal orientation.

18. A modular storage system comprising
at least one pair of spaced apart rail members, each rail member mounted on a substantially vertically oriented support structure in a substantially horizontal orientation,
at least one pair of panels space apart and mounted substantially vertically to extend from the support structure at substantially a right angle,
said panels being connected to the rail members by a plurality of panel clip members, and
at least one shelf member extending between the pair of panels in a substantially horizontal orientation, said shelf member having opposed ends with one opposed end connected to one panel by a first pair of spaced apart shelf clip members and the other opposed end connected to the other panel by a second pair of spaced apart shelf clip members.

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. A modular storage system including
a gondola support having a base and a plurality of uprights in a row extending from the base at an angle of substantially 90°, said uprights including a series of indexing sites positioned in an equally spaced apart sequence,
a first rail member detachably connected to an adjacent pair of uprights to form a right angle with respect to the uprights, said first rail member having at each opposed ends thereof a connector element that engages one of the indexing sites along the upright to detachably connect the rail member to the upright,
a second rail member spaced form said first rail member and connected to said adjacent pair of uprights to form a right angle with respect to the uprights, said second rail member having at each opposed ends thereof a connector element that engages at least one of the indexing sites along the upright to detachably connect the rail member to the upright,
a first panel detachably connected to the rail members by first and second spaced apart panel clip members, the first clip member having one segment that detachably connects to the first rail member and another segment that engages an inner lateral edge of the first panel, and the second clip member having one segment that detachably connects to the second rail member and another segment that engages an inner lateral edge of the first panel along another portion than the segment of the first clip member,
a second panel spaced apart and nearby the first panel and detachably connected to the rail members by third and forth spaced apart panel clip members, the third clip member having one segment that detachably connects to the first rail member and another segment that engages an inner lateral edge of the second panel, and the forth clip member having one segment that detachably connects to the second rail member and another segment that engages an inner lateral edge of the second panel along another portion than the segment of the third clip member,
said first and second panels being substantially parallel to each other and substantially a right angle to the base, and
at least one support member extending between the first and second panels substantially at a right angle thereto and detachably connected to said panels.

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)

64. (canceled)

65. (canceled)

66. A method of storing items comprising
mounting a pair of spaced apart planar members to one or more horizontal support members with at least one clip member connecting a planar member to a horizontal support member,
each said clip member having a first element that fits snugly over an edge of a horizontal support member and a second portion that fits snugly over an inside edge of the planar member to which said clip member is connected to form a rigid cantilever structure,
mounting between said planar members a horizontal shelf, and
storing on the shelf said items.

67. A kit for a modular storage system comprising
a plurality of rail members, each rail member adapted to be mounted on a substantially vertically oriented support structure in a substantially horizontal orientation, and
a plurality of panel clip members, each panel clip member having a first segment adapted to be detachably connected to one rail member mounted to the support structure and a second segment adapted to be detachably connected a panel to mount said panel in a substantially vertical orientation.

68. A modular storage system adapted to be mounted to a vertical wall, comprising
a pair of horizontal cleat members fixedly attached to the vertical wall and spaced apart vertically a predetermined distance, each cleat member including an upper horizontal edge forming an acute angle with respect to said wall,
a back panel having a pair of horizontally oriented mounting members attached to an exterior surface of the back panel, said mounting members each having a rhomboidal cross-sectional configuration and being vertically spaced apart a distance substantially equal to said predetermined distance,
at least one pair of side panels, each said side panel having an inner edge with a pair of cut-a-way sections each having a rhomboidal cross-sectional configuration substantially identical to the rhomboidal cross-sectional configuration of the mounting members,
said pair of cut-a-way sections being spaced apart a distance substantially equal to the distance between the mounting members and each individual cut-a-way section of said pair of cut-a-way sections being seated on one of the mounting members,
said pair of side panels being spaced apart along the pair of mounting members and substantially vertically oriented and extending outward from the wall at substantially a right angle.

69. The modular storage system of claim 68 at least one substantially horizontally oriented member extending between the side panels.

70. The modular storage system of claim 68 where the cleat members are substantially in registration and the side panels are substantially in registration.

71. The modular storage system of claim 68 where the cross-sectional configurations of each cleat member is substantially identical.

72. A modular storage system adapted to be mounted to a vertical wall, comprising
at least one horizontal mounting member fixedly attached to the vertical wall,
said mounting member having a predetermined cross-sectional configuration and a pair of opposed horizontal edges, each forming a predetermined angle with respect to said wall,
at least one pair of side panels, each said side panel having an inner edge with at least one cut-a-way section having a configuration corresponding to the cross-sectional configuration of the mounting member, said side panels each being seated on the mounting member with the mounting member and cut-a-way section of each side panel fitting snugly together,
said pair of side panels being spaced apart along the mounting member and substantially vertically oriented and extending outward from the wall at substantially a right angle.

73. (canceled)

74. A modular storage system adapted to be mounted to a vertical wall, comprising
pair of horizontal cleat members fixedly attached to the vertical wall and spaced apart vertically a predetermined distance,
each cleat member having a predetermined cross-sectional configuration and each cleat member including an upper horizontal edge forming an acute angle with respect to said wall,
a back panel having a pair of substantially horizontally oriented mounting members that are spaced apart vertically and fixedly attached to an exterior surface of the back panel, said mounting members each having upper and lower substantially horizontal edges and a predetermined cross-sectional configuration, said lower edge of one of the mounting members engaging the upper edge of one of the cleat members and said lower edge of the other mounting member engaging the upper edge of the other cleat member, said lower edges each having an acute angle substantially equal to the acute angle of the cleat member upper edge being engaged,
at least one pair of side panels, each said side panel having an inner edge with a pair of cut-a-way sections, one cut-a-way section having a configuration substantially corresponding to the cross-sectional configuration of one of the mounting members and the other cut-a-way section having a configuration substantially corresponding to the cross-sectional configuration of the other mounting member,
said pair of cut-a-way sections being spaced apart a distance substantially equal to the distance between the mounting members and each individual cut-a-way section of said pair of cut-a-way sections being seated on one of the mounting members,
said pair of side panels being spaced apart a predetermined distance horizontally along the pair of mounting members and substantially vertically oriented and extending outward from the wall at substantially a right angle, and
at least one substantially horizontally oriented member extending between the side panels.

75. The modular storage system of claim 74 where the mounting members are substantially in registration and the side panels are substantially in registration.

76. The modular storage system of claim 75 where the cross-sectional configurations of each cleat member is substantially identical.

77. The modular storage system of claim 76 where the cross-sectional configurations of each cleat member is substantially rhomboidal.

78. The modular storage system of claim 74 where the cleat members each have a predetermined length that is less than the distance between the side panels, said cleat members being positioned relative to the back panel to provide a space between the wall and the cleat members into which the edge of at least one side panel is received upon being seated on the mounting members.

79. A modular storage system adapted to be mounted to a vertical wall, comprising
at least one horizontal cleat member fixedly attached to the vertical wall and having a predetermined cross-sectional configuration including an upper horizontal edge forming an acute angle with respect to said wall,
a back panel having at least one substantially horizontally oriented mounting member that is fixedly attached to an exterior surface of the back panel and has a lower edge and a predetermined cross-sectional configuration, said lower edge of the mounting member engaging the upper horizontal edge of the cleat member, said lower edge having an acute angle substantially equal to the acute angle of said upper horizontal edge of the cleat member being engaged,
at least one pair of side panels, each said side panel having an inner edge with at least one cut-a-way section having a configuration substantially corresponding to the cross-sectional configuration of the mounting member,
said pair of side panels being spaced apart a predetermined distance horizontally along the mounting member and substantially vertically oriented and extending outward from the wall at substantially a right angle, said side panels being seated on the cleat member with the cleat member and cut-a-way sections of the side panels fitting snugly together, and
at least one substantially horizontally oriented member extending between the side panels.

80. A kit for a modular storage system comprising
a back panel having a mounting member fixedly attached to an exterior surface of the back panel, said mounting member having upper and lower substantially parallel edges and a predetermined cross-sectional configuration, said lower edge of the mounting member being adapted to engage an edge of a cleat member fixedly attached to a vertical wall in a substantially horizontal orientation so that mounting member is substantially horizontally orientated when the back panel is mounted on the cleat member,
at least one pair of side panels, each said side panel having an inner edge with at least one cut-a-way section having a configuration substantially corresponding to the cross-sectional configuration of the mounting member, said cut-a-way section being adapted to be seated snugly on the mounting member,
said pair of side panels being adapted to be spaced apart along the mounting member and substantially vertically oriented and extending outward from the wall at substantially a right angle.

81. The kit of claim 80 where said lower edge of the mounting member is adapted to engage the upper edge the cleat member, which forms an acute angle with respect to the wall, said lower edge of the mounting member having an acute angle substantially equal to the acute angle of the cleat member edge being engaged upon mounting the side panels.
